(19) United States
(12) Patent Application Publication
(10) Pub. No.: US 2018/0244699 A1
(43) Pub. Date: Aug. 30, 2018

(54) 1-HYDROXY-3H-2,1-BENZOXABOROLE DERIVATIVES AND THEIR USE AS MICROBIOCIDES

(71) Applicant: Syngenta Participations AG, Basel (CH)

(72) Inventors: Ramya RAJAN, Corlim IIhas (IN); Peter RENOLD, Stein (CH); Daniel STIERLI, Stein (CH); Renaud BEAUDEGINES, Stein (CH)

(73) Assignee: Syngenta Participations AG, Basel (CH)

(21) Appl. No.: 15/753,460

(22) PCT Filed: Aug. 16, 2016
(86) PCT No.: PCT/EP2016/069430

§ 371 Date: Feb. 19, 2018

(30) Foreign Application Priority Data
Aug. 17, 2015 (IN) 2538/DEL/2015

(51) Int. Cl. C07F 5/02; A01N 55/08

(52) U.S. Cl. CPC C07F 5/025; A01N 55/08

(57) ABSTRACT

Compounds of formula (I) wherein R¹ is fluorine, chlorine, bromine, cyano, nitro, hydroxy, C₁-C₄alkoxy, C₁-C₄haloalkoxy; G=OR², NR³R⁴R², R³ and R⁴ independently are selected H, alkyl, aryl, heteroaryl, cacloalkyl, heterocycloalkyl, wherein the alkyl, aryl, heteroaryl, cacloalkyl, heterocycloalkyl moieties may be further substituted; are useful as a pesticides especially fungicide.

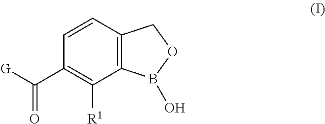

The present invention relates to novel microbiocidally active, in particular fungicidally active, oxoboroles moiety containing compounds their use in compositions and methods for the control and/or prevention of microbial infection, particularly fungal infection, in plants or plant propagation material, harvested food crops by phytopathogenic microorganisms, preferably fungi and to processes for the preparation of these compounds. Preferably these compounds are used in agriculture or horticulture for controlling or preventing infestation of plants by phytopathogenic microorganisms, preferably fungi.

The incidence of serious microbial infections, particularly fungal infections, either systemic or topical, continues to increase for plants.

Fungicides are compounds, of natural or synthetic origin, which act to protect plants against damage caused by fungi. Current methods of agriculture rely heavily on the use of fungicides. In fact, some crops cannot be grown usefully without the use of fungicides. Using fungicides allows a grower to increase the yield of the crop and consequently, increase the value of the crop. Numerous fungicidal agents have been developed. However, the treatment of fungal infestations continues to be a major problem. Furthermore, fungicide resistance has become a serious problem, rendering these agents ineffective for some agricultural uses. As such, a need exists for the development of new fungicidal compounds with improved antifungal properties. It has been found that novel oxoborazoles with a specific substitution pattern are novel and have improved microbiocidal activity.

The present invention relates to compounds of formula (I)

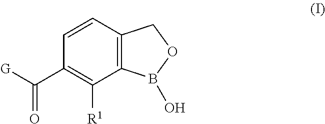

wherein
R¹ is fluorine, chlorine, bromine, cyano, nitro, hydroxy, C₁-C₄alkoxy, C₁-C₄haloalkoxy;
G=OR², NR³R⁴
R², R³ and R⁴ independently are H, C₁-C₆alkyl which can be substituted by one or more R⁵, C₁-C₆haloalkyl, 6 to 14 membered aryl which can be substituted by one or more R⁵, five to six membered heteroaryl which can be substituted by one or more R⁵ comprising 1 to 3 hetero atoms selected from the group consisting of nitrogen, oxygen and sulfur, it not being possible for the ring system to contain more than 2 oxygen atoms and more than 2 sulfur atoms, C₃-C₆cycloalkyl which can be substituted by one or more R⁵, heterocycloalkyl which can be substituted by one or more R⁵ containing 5 to 6 ring members comprising 1 to 3 hetero atoms selected from the group consisting of nitrogen, oxygen and sulfur, it not being possible for the ring system to contain more than 2 oxygen atoms and more than 2 sulfur atoms, C₁-C₆alkoxy which can be substituted by one or more R⁵, C₂-C₆alkenyl which can be substituted by one or more R⁵, C₂-C₆alkynyl which can be substituted by one or more R⁵, or
R³ and R⁴ form together with the nitrogen to which they are attached a 5 to 9 ring containing 1 to 3 hetero atoms selected from the group consisting of nitrogen, oxygen and sulfur, it not being possible for the ring system to contain more than 2 oxygen atoms and more than 2 sulfur atoms which can be substituted by one or more R⁵,
R⁵ is independently selected from oxo, —OH, CN, NO₂, F, Cl, —C(O)(C₁₋₄ alkoxy), —C(O)(C₁₋₄ alkyl), —C(O)—NH—(C₁₋₄ alkyl), —C(O)—N(C₁₋₄ alkyl)₂, C₃-C₇-cycloalkyl, 6 to 14 membered aryl, five to seven membered heteroaryl comprising 1 to 3 hetero atoms selected from the group consisting of nitrogen, oxygen and sulfur, it not being possible for the ring system to contain more than 2 oxygen atoms and more than 2 sulfur atoms, five to seven membered heterocycloalkyl comprising 1 to 3 hetero atoms selected from the group consisting of nitrogen, oxygen and sulfur, it not being possible for the ring system to contain more than 2 oxygen atoms and more than 2 sulfur atoms, C₁-C₄alkyl, C₁-C₄haloalkyl, C₂-C₄alkenyl, C₁-C₄haloalkenyl, C₂-C₆alkinyl, C₁-C₆alkoxy, C₂-C₆alkenyloxy, C₂-C₆haloalkenyloxy, C₂-C₆alkinyloxy, C₂-C₆haloalkinyl;
provided if R¹ is F then R² is not H.
and agronomically acceptable salts, stereoisomers, diastereoisomers, enantiomers, tautomers, atriopisomers and N-oxides of those compounds.

Where substituents are indicated as being optionally substituted, this means that they may or may not carry one or more identical or different substituents, e.g. one to three substituents. Normally not more than three such optional substituents are present at the same time. Where a group is indicated as being substituted, e.g. alkyl, this includes those groups that are part of other groups, e.g. the alkyl in alkoxy or phenyl in phenyloxy.

The number of substituents does not exceed the number of available C—H and N—H bonds, for example in the aryl group substituted by one or more R⁵ has only one to five substituents if phenyl is meant.

The term “halogen” refers to fluorine, chlorine, bromine or iodine, preferably fluorine, chlorine or bromine.

Alkyl substituents can be straight-chained or branched. Alkyl on its own or as part of another substituent is, depending upon the number of carbon atoms mentioned, for example, methyl, ethyl, n-propyl, n-butyl, n-pentyl, n-hexyl and the isomers thereof, for example, iso-propyl, iso-butyl, sec-butyl, tert-butyl or iso-amyl.

Cycloalkyl includes cyclopropyl, cyclobutyl, cyclopentyl and cyclohexyl.

Alkenyl substituents can be in the form of straight or branched chains, and the alkenyl moieties, where appropriate, can be of either the (E)- or (Z)-configuration. Examples are vinyl and allyl. The alkenyl groups are preferably C₂-C₆, more preferably C₂-C₄ and most preferably C₂-C₃ alkenyl groups.

Alkynyl substituents can be in the form of straight or branched chains. Examples are ethynyl and propargyl. The alkynyl groups are preferably C₂-C₆, more preferably C₂-C₄ and most preferably C₂-C₃ alkynyl groups.

Haloalkyl groups may contain one or more identical or different halogen atoms and, for example, may stand for CH₂Cl, CHCl₂, CCl₃, CH₂F, CHF₂, CF₃, CF₃CH₂, CH₃CF₂, CF₃CF₂ or CCl₃CCl₂.

Haloalkenyl groups are alkenyl groups, respectively, which are substituted with one or more of the same or different halogen atoms and are, for example, 2,2-difluorovinyl or 1,2-dichloro-2-fluoro-vinyl.

Alkoxy means a radical —OR, where R is alkyl, e.g. as defined above. Alkoxy groups include, but are not limited to, methoxy, ethoxy, 1-methylethoxy, propoxy, butoxy, 1-methylpropoxy and 2-methylpropoxy.

Haloalkoxy means a radical —OR, where R is haloalkyl, e.g. is described above. Haloalkloxy groups include, but are not limited to, CH₂ClO, CHCl₂O, CCl₃O, CH₂FO, CHF₂O—, CF₃O—, CF₃CH₂O—, CH₃CF₂O or CCl₃CCl₂O—.

Cyano means a —CN group.

Amino means an —NH₂ group.

Hydroxyl or hydroxy stands for a —OH group.

Aryl means a six to fourteen membered aromatic carbocyclic ring system which can be mono-, bi- or tricyclic. Examples of such rings include phenyl, indenyl, naphthalenyl, anthranyl, or phenanthrenyl. A preferred aryl group is phenyl.

Heteroaryl stands for a five to six membered ring system which can be substituted by one or more R⁵ comprising 1 to 3 hetero atoms selected from the group consisting of nitrogen, oxygen and sulfur, it not being possible for the ring system to contain more than 2 oxygen atoms and more than 2 sulfur atoms. Examples of heteroaryl are furyl, thienyl, pyrrolyl, imidazolyl, pyrazolyl, thiazolyl, isothiazolyl, oxazolyl, isoxazolyl, oxadiazolyl, thiadiazolyl, triazolyl, tetrazolyl, pyridyl, pyridazinyl, pyrimidinyl, pyrazinyl. A preferred heteroaryl group is pyridyl.

The presence of one or more possible asymmetric carbon atoms in a compound of formula I means that the compounds may occur in optically isomeric forms, i.e. enantiomeric or diastereomeric forms. Also atropisomers may occur as a result of restricted rotation about a single bond. Formula I is intended to include all those possible isomeric forms and mixtures thereof. The present invention includes all those possible isomeric forms and mixtures thereof for a compound of formula I. Likewise, formula I is intended to include all possible tautomers. The present invention includes all possible tautomeric forms for a compound of formula (I).

In each case, the compounds of formula I according to the invention are in free form, in oxidized form as a N-oxide or in salt form, e.g. an agronomically usable salt form.

N-oxides are oxidized forms of tertiary amines or oxidized forms of nitrogen containing heteroaromatic compounds. They are described for instance in the book “Heterocyclic N-oxides” by A. Albini and S. Pietra, CRC Press, Boca Raton 1991.

The term “fungicide” as used herein means a compound that controls, modifies, or prevents the growth of fungi. The term “fungicidally effective amount” means the quantity of such a compound or combination of such compounds that is capable of producing an effect on the growth of fungi. Controlling or modifying effects include all deviation from natural development, such as killing, retardation and the like, and prevention includes barrier or other defensive formation in or on a plant to prevent fungal infection. The term “herbicide” as used herein means a compound that controls or modifies the growth of plants. The term “herbicidally effective amount” means the quantity of such a compound or combination of such compounds that is capable of producing a controlling or modifying effect on the growth of plants. Controlling or modifying effects include all deviation from natural development, for example killing, retardation, leaf burn, albinism, dwarfing and the like.
The term “insecticide” as used herein means a compound that controls or modifies the growth of insects. The term “insecticidally effective amount” means the quantity of such a compound or combination of such compounds that is capable of killing, controlling, or infecting insects, retarding the growth or reproduction of insects, reducing an insect population, and/or reducing damage to plants caused by insects. The term “locus” as used herein means fields in or on which plants are growing, or where seeds of cultivated plants are sown, or where seed will be placed into the soil. It includes soil, seeds, and seedlings, as well as established vegetation.
The term “metabolism” as used herein means the conversion or breakdown of a substance from one form to another by a living organism.
The term “nematicide” as used herein means a compound that controls or modifies the growth of nematodes.
The term “nematicidally effective amount” means the quantity of such a compound or combination of such compounds that is capable of killing, controlling, or infecting nematodes, retarding the growth or reproduction of nematodes, reducing a nematode population, and/or reducing damage to plants caused by nematodes. A nematicidally effective amount” as used herein refers to an amount of nematicide capable of killing, controlling, or infecting nematodes, retarding the growth or reproduction of nematodes, reducing a nematode population, and/or reducing damage to plants caused by nematodes

The term “plants” refers to all physical parts of a plant, including seeds, seedlings, saplings, roots, tubers, stems, stalks, foliage, and fruits.

The following list provides definitions, including preferred definitions, for substituents R¹, R², R³, R⁴, R⁵ and G with reference to compounds of formula I. For any one of these substituents, any of the definitions given below can be combined with any definition of any other substituent given below or elsewhere in this document.

### Preferably

R¹ is OH, C₁-C₄alkoxy, C₁-C₄haloalkoxy;
G is OR², NR³R⁴;
R² is a C₁-C₆alkyl, C₁-C₆haloalkyl, phenyl-C₀-C₄-alkyl which can be substituted by one or more R⁵;
R³ is H, C₁-C₄-alkyl;
R⁴ is C₁-C₆alkyl which can be substituted by one or more R⁵, C₁-C₆haloalkyl, phenyl-C₀-C₄-alkyl which can be substituted by one or more R⁵, pyridyl-C₀-C₄-alkyl which can be substituted by one or more R⁵, C₃-C₆cycloalkyl which can be substituted by one or more R⁵, five to six ring member comprising heterocycloalkyl-C₀-C₄-alkyl which can be substituted by one or more R⁵ wherein the heterocycloalkyl group comprises 1 to 3 heteroatoms selected from O, N and S, C₂-C₆alkenyl which can be substituted by one or more R⁵, C₂-C₆alkynyl which can be substituted by one or more R⁵, pyrimidinyl which can be substituted by one or more R⁵, triazolyl which can be substituted by one or more R⁵, pyrazinyl which can be substituted by one or more R⁵, pyrazolyl which can be substituted by one or more R⁵, pyrrolidinyl which can be substituted by one or more R⁵;
R⁵ is independently selected from F, Cl, OH, CN, methyl, ethyl, methoxy, ethoxy, C₁-C₆alkyl-carboxylate, sulfonylamide, phenyl.
More preferably
R¹ is OH, C₁-C₄alkoxy, C₁-C₄haloalkoxy;
G is OR², NR³R⁴;
R² is a C₁-C₆alkyl, C₁-C₆haloalkyl;
R³ is H, C₁-C₄-alkyl;
R⁴ is C₁-C₆alkyl which can be substituted by one or more R⁵, C₁-C₆haloalkyl, can be phenyl-C₀-C₄-alkyl substituted by one or more R⁵, pyridyl-C₀-C₄-alkyl which can be substituted by one or more R⁵, C₃-C₆cycloalkyl which can be substituted by one or more R⁵, five to six ringmember comprising heterocycloalkyl-C₀-C₄-alkyl which can be substituted by one or more R⁵ wherein the heterocycloalkyl group comprises 1 to 3 heteroatoms selected from O, N and S, C₂-C₆alkenyl which can be substituted by one or more R⁵, C₂-C₆alkynyl which can be substituted by one or more R⁵, pyrimidinyl which can be substituted by one or more R⁵, triazolyl which can be substituted by one or more R⁵, pyrazinyl which can be substituted by one or more R⁵, pyrazolyl which can be substituted by one or more R⁵, pyrrolidinyl which can be substituted by one or more R⁵;
R⁵ is independently selected from F, Cl, OH, CN, methyl, ethyl, methoxy, ethoxy, C₁-C₆alkyl-carboxylate, sulfonylamide, phenyl.
In one preferred embodiment of the invention G is NR³R⁴
In one preferred embodiment of the invention G is OR²;
In a more preferred embodiment of the invention G is OR²;
Further preferred compounds according to the invention are compounds of formula (I) wherein
R¹ is fluorine, chlorine, bromine, cyano, nitro, hydroxy, C₁-C₄alkoxy, C₁-C₄haloalkoxy preferably R¹ is OH, Cl, methoxy, ethoxy, difluormethoxy;
G=OR², NR³R⁴;
R² is H, isopentyl, methyl, (1-methyl-3-phenyl-propyl), (1S)-2-ethoxy-1-methyl-2-oxo-ethyl, (2,5-dichlorophenyl)methyl, (2,6-dichloro-4-hydroxy-phenyl)methyl, (2,6-dichloro-4-pyridyl)methyl, (2-ethyl-4-methyl-5H-oxazol-4-yl)methyl, (2-methoxyphenyl)methyl, (2-methylcyclopropyl)methyl, (2-oxo-1,3-dioxolan-4-yl)methyl, (3,3,3-trifluoro-1-phenyl-propyl), (3,5-dimethylphenyl)methyl, (3,5-dimethylpyrazol-1-yl)methyl, (4,5-dichloroimidazol-1-yl)methyl, (4-hydroxy-3-methoxy-phenyl)methyl, (4-methoxyphenyl)methyl, (4-m ethylthiazol-2-yl)methyl, (5-chloro-3-fluoro-2-pyridyl)methyl, (5-methyl-2-propyl-1,3-dioxan-5-yl)methyl, (6-methyl-2-pyridyl)methyl, [4-(methoxycarbonylamino)phenyl]methyl, 1-(3-chlorophenyl)ethyl, 1,2,4-triazol-1-ylmethyl, 1,3-dioxan-5-yl, 1,3-dithiolan-2-ylmethyl, 1-[3-(trifluoromethyl)-1H-pyrazol-5-yl]ethyl, 1-ethylprop-2-ynyl, 2-(2-fluorophenyl)ethyl, 2-(2-methylphenoxy)ethyl, 2-(2-pyridyl)ethyl, 2-(4-chlorophenoxy)ethyl, 2-(4-methylthiazol-5-yl)ethyl, 2-(5-acetoxy-3-methyl-pyrazol-1-yl)ethyl, 2-(5-hydroxy-3-sulfanyl-1,2,4-triazin-6-yl)-2-methyl-propyl, 2-(diethylamino)-2-oxo-ethyl, 2-(isopropylideneamino)oxyethyl, 2,2,2-trifluoroethyl, 2,2-difluoroethyl, 2,2-difluoropropyl, 2,2-dimethyl-3-phenyl-propyl), 2,6-dimethoxypyrimidin-4-yl)methyl, 2-[tert-butoxycarbonyl(methyl)amino]ethyl, 2-ethoxy-2-oxo-ethyl, 2-isopropoxyethyl, 2-methoxy-2-phenyl-ethyl, 2-methyl-3-pyridyl)methyl, 3-(3-m ethoxyphenyl)prop-2-ynyl, 3-(4-chlorophenyl)prop-2-ynyl, 3-(trifluoromethyl)phenyl]methyl, 3,4-dihydro-2H-pyran-2-ylmethyl, 3-ethoxy-3-oxo-1-(trifluoromethyl)propyl, 4-cyanophenyl, 4-methoxy-4-oxo-but-2-ynyl, 4-pyridylmethyl, acetonyl, benzyl, cyclopent-3-en-1-yl, dimethyl (2S)-2-oxybutanedioate, pent-3-ynyl, phenethyl, pyrazol-1-ylmethyl;
R³ is H, C₁-C₄-alkyl;
R⁴ is methyl, ethyl, isobutyl, phenethyl, isopropyl, (2-fluorophenyl)methyl, (4-chlorophenyl)methyl, 2-pyridylmethyl, 4-cyanophenyl, phenyl, ethyl piperidine-1-carboxylate-4-amine, 2,5-dimethylphenyl, 1-(3,5-difluoro-2-pyridyl, dimethylcarbamoyl), 4,6-dimethyl-2-pyridyl, (2,4-dichlorophenyl)methyl, 3-methylisothiazol-5-yl, phenylethyl, 2-methoxyethyl, 4-methyl-5-sulfamoyl-thiazol-2-yl, 4-ethylphenyl, 2-pyridyl, 2-chloro-6-methyl-phenyl)methyl, isoxazol-4-yl, ethyl 1-carbocylate-cyclopropane-1-yl, 2,4-diisopropyl-3-pyridyl, 2,5-dichloro-3-pyridyl, 5-ethylsulfanyl-1-methyl-1,2,4-triazol-3-yl, 3-chloro-4-ethoxy-phenyl, 2-methyl-4-pyridyl, 5-methyl-4H-1,2,4-triazol-3-yl, methyl 2-butanoate, 2-isopropyl-5-methyl-pyrimidin-4-yl, 5-(trifluoromethyl)-1H-1,2,4-triazol-3-yl, methyl(3-pyridylmethyl)carbamothioyl, 3-pyridylmethyl, 5-(trifluoromethyl)-1,3,4-thiadiazol-2-yl, 1H-1,2,4-triazol-5-yl, 3-methoxy-1H-1,2,4-triazol-5-yl, methyl 3-benzoate, phenylmethyl, 4-chloro-2-fluoro-phenyl, 4-(trifluoromethoxy)phenyl, 2-phenoxyethyl, 4-fluorophenyl)ethyl, 4,6-dimethoxypyrimidin-2-yl, 6-chloro-3-pyridyl)methyl, tert-butyl, methyl 3-pyrazine-2-carboxylate, 2,2,3,3-tetrafluorocyclobutyl)methyl, propyl, 5-methyl-2-pyridyl, methyl 1-methyl-pyrrole-2-carboxylate-4-yl, trifluoromethyl)-2-pyridyl]methyl, 4-ethyl-1,3-dioxolan-2-yl)methyl, 5-[(5-methyl-2-furyl)methyl, 3-amino-5-methyl-pyrazol-1-yl, 2-hydroxymethyl)pyrrolidin-1-yl;
or R³ and R⁴ form together with the nitrogen to which the are attached a 2,5,5-trimethylmorpholin-4-yl or methyl 4-carboxylate-piperidine moiety;
provided if R¹ is fluorine then R² is not H.
Further more preferred compounds according to the invention are compounds of formula (I) wherein R¹ is OH, Cl, methoxy, ethoxy, difluormethoxy preferably R¹ is OH, methoxy, ethoxy;
G=OR², NR³R⁴;
R² is H, isopentyl, methyl, (1-methyl-3-phenyl-propyl), (1S)-2-ethoxy-1-methyl-2-oxo-ethyl, (2,5-dichlorophenyl)methyl, (2,6-dichloro-4-hydroxy-phenyl)methyl, (2,6-dichloro-4-pyridyl)methyl, (2-ethyl-4-methyl-5H-oxazol-4-yl)methyl, (2-m ethoxyphenyl)methyl, (2-methylcyclopropyl)methyl, (2-oxo-1,3-dioxolan-4-yl)methyl, (3,3,3-trifluoro-1-phenyl-propyl), (3,5-dimethylphenyl)methyl, (3,5-dimethylpyrazol-1-yl)methyl, (4,5-dichloroimidazol-1-yl)methyl, (4-hydroxy-3-methoxy-phenyl)methyl, (4-methoxyphenyl)methyl, (4-methylthiazol-2-yl)methyl, (5-chloro-3-fluoro-2-pyridyl)methyl, (5-methyl-2-propyl-1,3-dioxan-5-yl)methyl, (6-methyl-2-pyridyl)methyl, [4-(methoxycarbonylamino)phenyl]methyl, 1-(3-chlorophenyl)ethyl, 1,2,4-triazol-1-ylmethyl, 1,3-dioxan-5-yl, 1,3-dithiolan-2-ylmethyl, 1-[3-(trifluoromethyl)-1H-pyrazol-5-yl]ethyl, 1-ethylprop-2-ynyl, 2-(2-fluorophenyl)ethyl, 2-(2-methylphenoxy)ethyl, 2-(2-pyridyl)ethyl, 2-(4-chlorophenoxy)ethyl, 2-(4-methylthiazol-5-yl)ethyl, 2-(5-acetoxy-3-methyl-pyrazol-1-yl)ethyl, 2-(5-hydroxy-3-sulfanyl-1,2,4-triazin-6-yl)-2-methyl-propyl, 2-(diethylamino)-2-oxo-ethyl, 2-(isopropylideneamino)oxyethyl, 2,2,2-trifluoroethyl, 2,2-difluoroethyl, 2,2-difluoropropyl, 2,2-dimethyl-3-phenyl-propyl), 2,6-dimethoxypyrimidin-4-yl)methyl, 2-[tert-butoxycarbonyl(methyl)amino]ethyl, 2-ethoxy-2-oxo-ethyl, 2-isopropoxyethyl, 2-methoxy-2-phenyl-ethyl, 2-methyl-3-pyridyl)methyl, 3-(3-m ethoxyphenyl)prop-2-ynyl, 3-(4-chlorophenyl)prop-2-ynyl, 3-(trifluoromethyl)phenyl]methyl, 3,4-dihydro-2H-pyran-2-ylmethyl, 3-ethoxy-3-oxo-1-(trifluoromethyl)propyl, 4-cyanophenyl, 4-methoxy-4-oxo-but-2-ynyl, 4-pyridylmethyl, acetonyl, benzyl, cyclopent-3-en-1-yl, dimethyl (2S)-2-oxybutanedioate, pent-3-ynyl, phenethyl, pyrazol-1-ylmethyl; R³ is H, C₁-C₄-alkyl;
R⁴ is methyl, ethyl, isobutyl, phenethyl, isopropyl, (2-fluorophenyl)methyl, (4-chlorophenyl)methyl, 2-pyridylmethyl, 4-cyanophenyl, phenyl, ethyl piperidine-1-carboxylate-4-amine, 2,5-dimethylphenyl, 1-(3,5-difluoro-2-pyridyl, dimethylcarbamoyl), 4,6-dimethyl-2-pyridyl, (2,4-dichlorophenyl)methyl, 3-methylisothiazol-5-yl, phenylethyl, 2-methoxyethyl, 4-methyl-5-sulfamoyl-thiazol-2-yl, 4-ethylphenyl, 2-pyridyl, 2-chloro-6-methyl-phenyl)methyl, isoxazol-4-yl, ethly 1-carbocylate-cyclopropane-1-yl, 2,4-diisopropyl-3-pyridyl, 2,5-dichloro-3-pyridyl, 5-ethylsulfanyl-1-methyl-1,2,4-triazol-3-yl, 3-chloro-4-ethoxy-phenyl, 2-methyl-4-pyridyl, 5-methyl-4H-1,2,4-triazol-3-yl, methyl 2-butanoate, 2-isopropyl-5-methyl-pyrimidin-4-yl, 5-(trifluoromethyl)-1H-1,2,4-triazol-3-yl, methyl(3-pyridylmethyl)carbamothioyl, 3-pyridylmethyl, 5-(trifluoromethyl)-1,3,4-thiadiazol-2-yl, 1H-1,2,4-triazol-5-yl, 3-methoxy-1H-1,2,4-triazol-5-yl, methyl 3-benzoate, phenylmethyl, 4-chloro-2-fluoro-phenyl, 4-(trifluoromethoxy)phenyl, 2-phenoxyethyl, 4-fluorophenyl)ethyl, 4,6-dimethoxypyrimidin-2-yl, 6-chloro-3-pyridyl)methyl, tert-butyl, methyl 3-pyrazine-2-carboxylate, 2,2,3,3-tetrafluorocyclobutyl)methyl, propyl, 5-methyl-2-pyridyl, methyl 1-methyl-pyrrole-2-carboxylate-4-yl, trifluoromethyl)-2-pyridyl]methyl, 4-ethyl-1,3-dioxolan-2-yl)methyl, 5-[(5-methyl-2-furyl)methyl, 3-amino-5-methyl-pyrazol-1-yl, 2-hydroxymethyl)pyrrolidin-1-yl;
or R³ and R⁴ form together with the nitrogen to which the are attached a 2,5,5-trimethylmorpholin-4-yl or methyl 4-carboxylate-piperidine moiety.
Further even more preferred compounds according to the invention are compounds of formula (I) wherein
R¹ is OH, methoxy, ethoxy;

### G=OR²;

R² is H, isopentyl, methyl, (1-methyl-3-phenyl-propyl), (1S)-2-ethoxy-1-methyl-2-oxo-ethyl, (2,5-dichlorophenyl)methyl, (2,6-dichloro-4-hydroxy-phenyl)methyl, (2,6-dichloro-4-pyridyl)methyl, (2-ethyl-4-methyl-5H-oxazol-4-yl)methyl, (2-m ethoxyphenyl)methyl, (2-methylcyclopropyl)methyl, (2-oxo-1,3-dioxolan-4-yl)methyl, (3,3,3-trifluoro-1-phenyl-propyl), (3,5-dimethylphenyl)methyl, (3,5-dimethylpyrazol-1-yl)methyl, (4,5-dichloroimidazol-1-yl)methyl, (4-hydroxy-3-methoxy-phenyl)methyl, (4-methoxyphenyl)methyl, (4-methylthiazol-2-yl)methyl, (5-chloro-3-fluoro-2-pyridyl)methyl, (5-methyl-2-propyl-1,3-dioxan-5-yl)methyl, (6-methyl-2-pyridyl)methyl, [4-(methoxycarbonylamino)phenyl]methyl, 1-(3-chlorophenyl)ethyl, 1,2,4-triazol-1-ylmethyl, 1,3-dioxan-5-yl, 1,3-dithiolan-2-ylmethyl, 1-[3-(trifluoromethyl)-1H-pyrazol-5-yl]ethyl, 1-ethylprop-2-ynyl, 2-(2-fluorophenyl)ethyl, 2-(2-methylphenoxy)ethyl, 2-(2-pyridyl)ethyl, 2-(4-chlorophenoxy)ethyl, 2-(4-methylthiazol-5-yl)ethyl, 2-(5-acetoxy-3-methyl-pyrazol-1-yl)ethyl, 2-(5-hydroxy-3-sulfanyl-1,2,4-triazin-6-yl)-2-methyl-propyl, 2-(diethylamino)-2-oxo-ethyl, 2-(isopropylideneamino)oxyethyl, 2,2,2-trifluoroethyl, 2,2-difluoroethyl, 2,2-difluoropropyl, 2,2-dimethyl-3-phenyl-propyl), 2,6-dimethoxypyrimidin-4-yl)methyl, 2-[tert-butoxycarbonyl(methyl)amino]ethyl, 2-ethoxy-2-oxo-ethyl, 2-isopropoxyethyl, 2-methoxy-2-phenyl-ethyl, 2-methyl-3-pyridyl)methyl, 3-(3-m ethoxyphenyl)prop-2-ynyl, 3-(4-chlorophenyl)prop-2-ynyl, 3-(trifluoromethyl)phenyl]methyl, 3,4-dihydro-2H-pyran-2-ylmethyl, 3-ethoxy-3-oxo-1-(trifluoromethyl)propyl, 4-cyanophenyl, 4-methoxy-4-oxo-but-2-ynyl, 4-pyridylmethyl, acetonyl, benzyl, cyclopent-3-en-1-yl, dimethyl (2S)-2-oxybutanedioate, pent-3-ynyl, phenethyl, pyrazol-1-ylmethyl.

The invention further relates to a process for the preparation of a compound of formula (I) and to compounds obtainable by this process

In all compounds shown in the schemes below R¹, R², R³, R⁴, R⁵ and G are as defined above.

Compounds described in the present invention can be prepared using commercially available starting materials or known intermediates using synthetic methods known in the art or described herein.

The following general chemistry routes were used as indicated in generating the examples and can be applied, using the knowledge of one of skill in the art, to other appropriate compounds to obtain additional analogues

Compounds of formula I may be prepared by reacting a compound of formula II

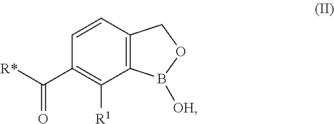

wherein R¹ is as defined under formula I R* is halogen, hydroxy or
C₁₋₆ alkoxy;
with a compound of formula III-A or III-B

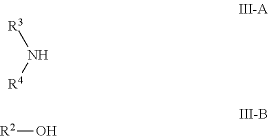

in which R², R³ and R⁴ are as defined under formula (I),
Compounds of formula III-A and III-B are known and commercially available.
The reactions for the preparation of compounds of formula I are advantageously carried out in aprotic inert organic solvents. Such solvents are hydrocarbons such as benzene, toluene, xylene or cyclohexane, chlorinated hydrocarbons such as dichloromethane, trichloromethane, tetrachloromethane or chlorobenzene, ethers such as diethyl ether, ethylene glycol dimethyl ether, diethylene glycol dimethyl ether, tetrahydrofuran or dioxane, nitriles such as acetonitrile or propionitrile, amides such as N,N-dimethylformamide, diethylformamide or N-methylpyrrolidinone. The reaction temperatures are advantageously between −20° C. and +120° C. In general, the reactions are slightly exothermic and, as a rule, they can be carried out at ambient temperature. To shorten the reaction time, or else to start the reaction, the mixture may be heated briefly to the boiling point of the reaction mixture. The reaction times can also be shortened by adding a few drops of base as reaction catalyst. Suitable bases are, in particular, tertiary amines such as trimethylamine, triethylamine, quinuclidine, 4-dimethylaminopyridine 1,4-diazabicyclo[2.2.2]octane, 1,5-diazabicyclo[4.3.0]non-5-ene or 1,5-diazabicyclo[5.4.0]undec-7-ene. However, inorganic bases such as hydrides, e.g. sodium hydride or calcium hydride, hydroxides, e.g. sodium hydroxide or potassium hydroxide, carbonates such as sodium carbonate and potassium carbonate, or hydrogen carbonates such as potassium hydrogen carbonate and sodium hydrogen carbonate may also be used as bases. The bases can be used as such or else with catalytic amounts of a phase-transfer catalyst, for example a crown ether, in particular 18-crown-6, or a tetraalkylammonium salt.

When R* is hydroxy, such reactions are usually carried out in the presence of a coupling reagent, such as DCC (N,N′-dicyclohexylcarbodiimide), EDC (1-ethyl-3-[3-dimethylamino-propyl]carbodiimide hydrochloride) or BOP-Cl (bis(2-oxo-3-oxazolidinyl)phosphonic chloride), in the presence of a base, such as pyridine, triethylamine, 4-(dimethylamino)-pyridine or diisopropylethylamine, and optionally in the presence of a nucleophilic catalyst, such as hydroxybenzotriazole. When R* is Cl, such reactions are usually carried out under basic conditions (for example in the presence of pyridine, triethylamine, 4-(dimethylamino)-pyridine or diisopropylethylamine), again optionally in the presence of a nucleophilic catalyst. Alternatively, it is possible to conduct the reaction in a biphasic system comprising an organic solvent, preferably ethyl acetate, and an aqueous solvent, preferably a solution of sodium bicarbonate. When R* is C₁-C₆alkoxy it is sometimes possible to convert the ester directly to the amide by heating the ester and amine together in a thermal process.

The intermediates of formula (II) can be prepared using synthetic methods described herein or in analogy to the methods described and incorporated by reference herein, such as WO 2015097276 A1 or Bioorg. Med. Chem. Lett. 2010, 20, 7317.

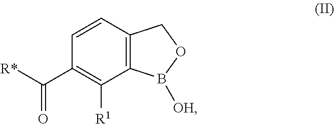

Compounds of formula (II) can be prepared by using the synthetic methods described herein. The Scheme-1, Scheme-2, Scheme-3 and Scheme-4 describes the synthetic route for the preparation of the key intermediate, formula (II)

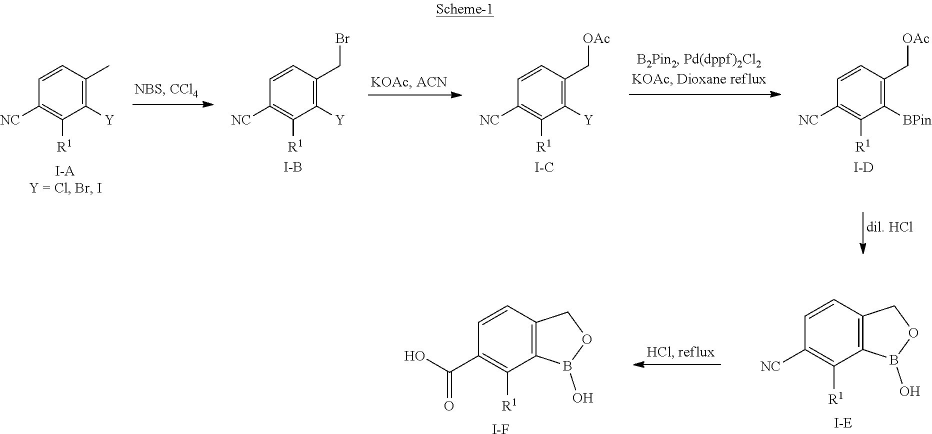

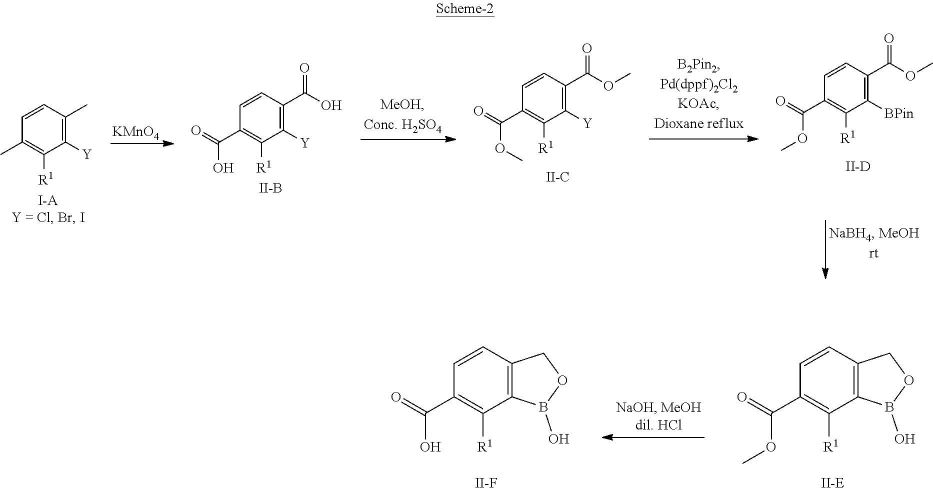

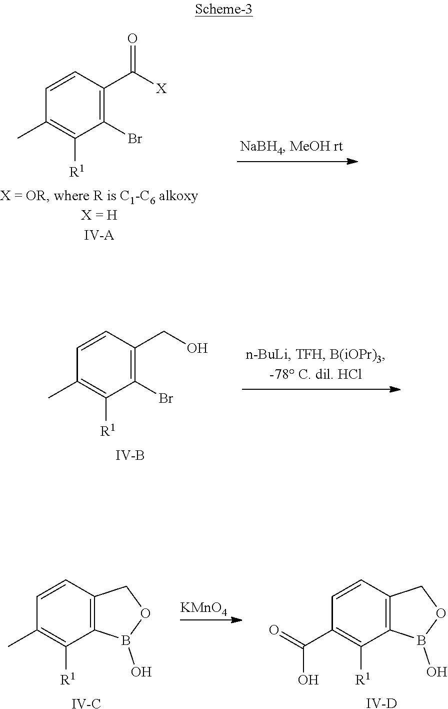

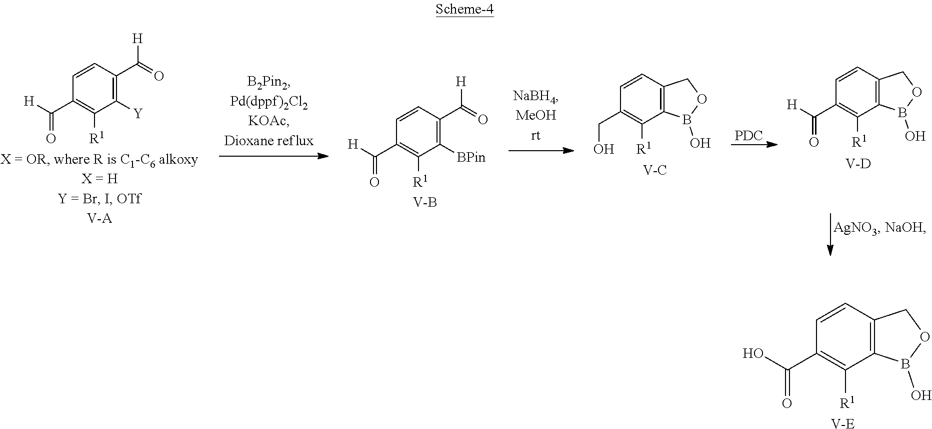

TABLE T2

| Cmpd | | | | |
|---|---|---|---|---|
| No. | G | R2 | R3 | R4 |
| T2.001 | OR² | Ethyl | — | — |
| T2.002 | OR² | prop-2-ynyl | — | — |
| T2.003 | OR² | 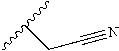 [SMILES: *CC#N] | — | — |
| T2.004 | OR² | Allyl | — | — |
| T2.005 | OR² | Isopropyl | — | — |
| T2.006 | OR² | 2-F-ethyl | — | — |
| T2.007 | OR² | 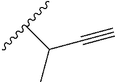 [SMILES: *C(C)C#C] | — | — |
| T2.008 | OR² | but-3-ynyl | — | — |
| T2.009 | OR² | but-2-ynyl | — | — |
| T2.010 | OR² | 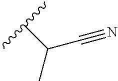 [SMILES: *C(C)C#N] | — | — |
| T2.011 | OR² | 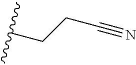 [SMILES: *CCC#N] | — | — |
| T2.012 | OR² | tetrahydrofuran-2-ylmethyl | — | — |
| T2.013 | OR² | 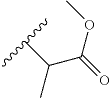 [SMILES: *C(C)C(=O)OC] | — | — |
| T2.014 | OR² | trimethylsilylmethyl | — | — |
| T2.015 | OR² | 3,3,3-trifluoropropyl | — | — |
| T2.016 | OR² | 4-methoxy-4-oxo-but-2-ynyl | — | — |
| T2.017 | OR² | 2-chloro-2,2-difluoro-ethyl | — | — |
| T2.018 | OR² | heptyl | — | — |
| T2.019 | OR² | 2-methylsulfonylethyl | — | — |
| T2.020 | OR² | (3-fluorophenyl)methyl | — | — |
| T2.021 | OR² | 3-trimethylsilylprop-2-ynyl | — | — |
| T2.022 | OR² | 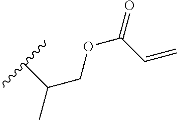 [SMILES: *C(C)COC(=O)C=C] | — | — |
| T2.023 | OR² | 1-methoxycarbonylbut-3-enyl | — | — |
| T2.024 | OR² | 3-trimethylsilylallyl | — | — |
| T2.025 | OR² | 1-phenylprop-2-ynyl | — | — |
| T2.026 | OR² | 3-phenylprop-2-ynyl | — | — |
| T2.027 | OR² | tetrahydrothiopyran-4-ylmethyl | — | — |
| T2.028 | OR² | 6-methoxytetrahydropyran-3-yl | — | — |
| T2.029 | OR² | 3-trimethylsilylpropyl | — | — |
| T2.030 | OR² | 2-butylsulfanylethyl | — | — |
| T2.031 | OR² | 2-(4-chlorophenoxy)ethyl | — | — |
| T2.032 | OR² | 2-ethoxycarbonylcyclohexyl | — | — |
| T2.033 | OR² | 6-(trifluoromethyl)-3-pyridyl]methyl | — | — |
| T2.034 | OR² | (4-phenylphenyl)methyl | — | — |
| T2.035 | OR² | 2-(2,6-dichlorophenyl)ethyl | — | — |
| T2.036 | OR² | 2-(2,4-dichlorophenyl)ethyl | — | — |
| T2.037 | OR² | 4-(2-naphthyl)butyl | — | — |
| T2.038 | OR² | [2-chloro-4- | — | — |
| | | (trifluoromethyl)phenyl]methyl | | |
| T2.039 | OR² | [3-chloro-5-(trifluoromethyl)2- | — | — |
| | | pyridyl]methyl | | |
| T2.040 | OR² | (4-oxo-4-pyrrolidin-1-yl-butyl) | — | — |
| T2.041 | OR² | 1-naphthylmethyl | — | — |
| T2.042 | OR² | 2-[2-(2-methoxyethoxy)ethoxy]ethyl | — | — |
| T2.043 | OR² | (2-methoxy-2-oxo-1-phenyl-ethyl) | — | — |
| T2.044 | OR² | 2-(4-methoxyphenoxy)ethyl | — | — |
| T2.045 | OR² | benzenesulfonylmethyl | — | — |
| T2.046 | OR² | phenacyl | — | — |
| T2.047 | OR² | cyclobutylmethyl | — | — |
| T2.048 | OR² | 2-dimethylaminoethyl | — | — |
| T2.049 | OR² | thietan-3-yl | — | — |
| T2.050 | OR² | [2-fluoro-1-(fluoromethyl)ethyl] | — | — |
| T2.051 | OR² | 3-(1-methylpyrazol-4-yl)propyl | — | — |
| T2.052 | OR² | (2-chlorothiazol-5-yl)methyl | — | — |
| T2.053 | OR² | 2-dimethoxyphosphorylethyl | — | — |
| T2.054 | OR² | 1-[ethoxy(methyl)phosphoryl]ethyl | — | — |
| T2.055 | OR² | (1-methyl-2-morpholino-ethyl) | — | — |
| T2.056 | NR³R⁴ | — | ethyl- | H |
| T2.057 | NR³R⁴ | — | butyl- | H |
| T2.058 | NR³R⁴ | — | but-2-yl- | H |
| T2.059 | NR³R⁴ | — | Allyl | H |
| T2.060 | NR³R⁴ | — | benzyl | H |
| T2.061 | NR³R⁴ | — | phenyl | H |
| T2.062 | NR³R⁴ | — | methyl | methoxy |
| T2.063 | NR³R⁴ | — | methyl | H |
| T2.064 | NR³R⁴ | — | methyl | methyl |
| T2.065 | NR³R⁴ | — | (1-methyl-1H-imidazol-4-yl)-methyl- | H |
| T2.066 | NR³R⁴ | — | (1H-benzimidazol-2-yl)-methyl- | H |
| T2.067 | NR³R⁴ | — | 3-bromo-propyl- | H |
| T2.068 | NR³R⁴ | — | 3,3,3-trifluoro-propyl- | H |
| T2.069 | NR³R⁴ | — | (1-hydroxycyclohexyl)methyl | H |
| T2.070 | NR³R⁴ | — | 2-oxotetrahydrothiophen-3-yl | H |
| T2.071 | NR³R⁴ | — | 6-ethoxycarbonylcyclohex-3-en-1-yl | H |
| T2.072 | NR³R⁴ | — | [2-hydroxy-2-(4-hydroxyphenyl)ethyl] | H |
| T2.073 | NR³R⁴ | — | 2-(1,3-benzodioxol-5-yl)ethyl | H |
| T2.074 | NR³R⁴ | — | 2-benzylsulfanylethyl | H |
| T2.075 | NR³R⁴ | — | 4-Methanesulfonyl-benzyl | H |
| T2.076 | NR³R⁴ | — | N′,N′-dimethylaminoethyl | H |
| T2.077 | NR³R⁴ | — | sec-Butyl | H |
| T2.078 | NR³R⁴ | — | Butan-1-ol-2-yl | H |
| T2.079 | NR³R⁴ | — | 1-methoxy-prop-2-yl- | H |
| T2.080 | NR³R⁴ | — | 2,2-Difluoro-ethyl | H |
| T2.081 | NR³R⁴ | — | Ethynyl-cyclohexyl | H |
| T2.082 | NR³R⁴ | — | 2-([1′,3′]dioxolan-2′-yl)-eth-1-yl- | H |
| T2.083 | NR³R⁴ | — | tetrahydrofuran-2-ylmeth-yl- | H |
| T2.084 | NR³R⁴ | — | 2-methyl-cyclohex-1-yl- | H |
| T2.085 | NR³R⁴ | — | 2-Morpholin-4-yl-ethyl | H |
| T2.086 | NR³R⁴ | — | 3-pyrrolidin-1-ylpropyl | H |
| T2.087 | NR³R⁴ | — | 2-sulfosulfanylethyl | H |
| T2.088 | NR³R⁴ | — | (pyrid-3-yl)-methyl- | H |
| T2.089 | NR³R⁴ | — | 3-(1-piperidyl)propyl | H |
| T2.090 | NR³R⁴ | — | Benzyl | H |
| T2.091 | NR³R⁴ | — | 3-(4-chlorophenyl)isoxazol-5-ylmethyl | H |
| T2.092 | NR³R⁴ | — | 2-fluoro-phenyl-meth-yl- | H |
| T2.093 | NR³R⁴ | — | 1-phenyl-eth-1-yl- | H |
| T2.094 | NR³R⁴ | — | 2-phenyl-eth-1-yl- | H |
| T2.095 | NR³R⁴ | — | (1,2,2,6,6-pentamethyl-4-piperidyl | H |
| T2.096 | NR³R⁴ | — | 2-(thiophen-2′-yl)-eth-1-yl- | H |
| T2.097 | NR³R⁴ | — | 2-Phenoxy-ethyl | H |
| T2.098 | NR³R⁴ | — | (3-chloro-phenyl)-methyl- | H |
| T2.099 | NR³R⁴ | — | (2,3-dihydro-benzo[1,4]dioxin-6-yl)- | H |
| | | | methyl- | |
| T2.100 | NR³R⁴ | — | 2-Acetylamino-ethyl | H |
| T2.101 | NR³R⁴ | — | (4-methoxy-phenyl)-methyl- | H |
| T2.102 | NR³R⁴ | — | 4-Pyrazol-1-yl-benzyl | H |
| T2.103 | NR³R⁴ | — | (2-trifluoromethoxy-phenyl)-methyl- | H |
| T2.104 | NR³R⁴ | — | 2-(indol-3′-yl)-eth-1-yl- | H |
| T2.105 | NR³R⁴ | — | 2-trifluoromethyl-benzyl- | H |
| T2.106 | NR³R⁴ | — | 2-Methylsulfanyl-ethyl | H |
| T2.107 | NR³R⁴ | — | 2-Piperidin-1-yl-benzyl | H |
| T2.108 | NR³R⁴ | — | 4-Phenoxy-benzyl | H |
| T2.109 | NR³R⁴ | — | (6-Chloro-pyridin-3-yl)-methyl | H |
| T2.110 | NR³R⁴ | — | 1-Benzyl-pyrrolidin-3-yl | H |
| T2.111 | NR³R⁴ | — | 2-Piperidin-1-yl-benzyl | H |
| T2.112 | NR³R⁴ | — | Furan-2-yl-methyl | H |
| T2.113 | NR³R⁴ | — | 2-chloro-phenyl- | H |
| T2.114 | NR³R⁴ | — | 4-methoxycarbonylphenyl | H |
| T2.115 | NR³R⁴ | — | 4-isopropylphenyl | H |
| T2.116 | NR³R⁴ | — | 2-methyl-phenyl- | H |
| T2.117 | NR³R⁴ | — | 2-chloro-6-methyl-phenyl- | H |
| T2.118 | NR³R⁴ | — | quinolin-5-yl- | H |
| T2.119 | NR³R⁴ | — | 2,4-dimethoxy-phenyl- | H |
| T2.120 | NR³R⁴ | — | 3-fluoro-phenyl- | H |
| T2.121 | NR³R⁴ | — | 1H-Indazol-5-yl | H |
| T2.122 | NR³R⁴ | — | 3-phenylphenyl | H |
| T2.123 | NR³R⁴ | — | 4-pyrrol-1-ylphenyl | H |
| T2.124 | NR³R⁴ | — | 4-Piperidin-1-yl-phenyl | H |
| T2.125 | NR³R⁴ | — | (2-benzoylphenyl) | H |
| T2.126 | NR³R⁴ | — | 2-methoxycarbonylbenzothiophen-5-yl | H |
| T2.127 | NR³R⁴ | — | 2-methoxy-5-phenyl-phenyl | H |
| T2.128 | NR³R⁴ | — | 2-methylsulfanylphenyl | H |
| T2.129 | NR³R⁴ | — | 1,3-benzothiazol-6-yl | H |
| T2.130 | NR³R⁴ | — | 2-morpholino-5-(trifluoromethyl)phenyl | H |
| T2.131 | NR³R⁴ | — | 2-(1H-indol-2-yl)phenyl | H |
| T2.132 | NR³R⁴ | — | 2-morpholinophenyl | H |
| T2.133 | NR³R⁴ | — | 4-Methyl-2-oxo-2H-chromen-7-yl | H |
| T2.134 | NR³R⁴ | — | 4-(dimethylsulfamoyl)phenyl | H |
| T2.135 | NR³R⁴ | — | 4-(2-pyridylsulfamoyl)phenyl | H |
| T2.136 | NR³R⁴ | — | 1,3-dimethyl-1H-pyrazol-5-yl- | H |
| T2.137 | NR³R⁴ | — | 4-methylthiazol-2-yl | H |
| T2.138 | NR³R⁴ | — | 5-methylsulfanyl-1H-[1,2,4]-triazol-3-yl | H |
| T2.139 | NR³R⁴ | — | 3-methyl-2-pyridyl | H |
| T2.140 | NR³R⁴ | — | 4-methyl-6-methylsulfanyl-1,3,5-triazin- | H |
| | | | 2-yl | |
| T2.141 | NR³R⁴ | — | 4-hydroxy-6-methyl-pyrimidin-2-yl | H |
| T2.142 | NR³R⁴ | — | 5-methoxycarbonyl-2-pyridyl | H |
| T2.143 | NR³R⁴ | — | Quinolin-2-yl | H |
| T2.144 | NR³R⁴ | — | 5-methyl-3-phenyl-isoxazol-4-yl | H |
| T2.145 | NR³R⁴ | — | 9H-Purin-6-yl | H |
| T2.146 | NR³R⁴ | — | 5-acetyl-4-methyl-thiazol-2-yl | H |
| T2.147 | NR³R⁴ | — | 5-phenyl-1H-pyrazol-3-yl | H |
| T2.148 | NR³R⁴ | — | 4-methyl-1,3-benzothiazol-2-yl | H |
| T2.149 | NR³R⁴ | — | 5-methyl-1,3,4-thiadiazol-2-yl | H |
| T2.150 | NR³R⁴ | — | 4-(4-chlorophenyl)thiadiazol-5-yl | H |
| T2.151 | NR³R⁴ | — | 6-phenoxy-3-pyridyl | H |
| T2.152 | NR³R⁴ | — | 3-cyano-5-phenyl-2-furyl | H |
| T2.153 | NR³R⁴ | — | 4-cyano-2-phenyl-pyrazol-3-yl | H |
| T2.154 | NR³R⁴ | — | 3-ethoxycarbonyl-4,5,6,7- | H |
| | | | tetrahydrobenzothiophen-2-yl | |
| T2.155 | NR³R⁴ | — | 2-methoxycarbonyl-3-thienyl | H |
| T2.156 | NR³R⁴ | — | 4-methyl-6-(2-thienyl)pyrimidin-2-yl | H |
| T2.157 | NR³R⁴ | — | 4,6-dimethyl-2H-pyrazolo[3,4- | H |
| | | | b]pyridin-3-yl | |
| T2.158 | NR³R⁴ | — | 4-(p-tolyl)thiazol-2-yl | H |
| T2.159 | NR³R⁴ | — | 5-phenyl-2-pyridyl | H |

| | | | |
|---|---|---|---|
| T2.160 | NR³R⁴ | — | —CH2—CH2—O—CH2—CH2— |
| T2.161 | NR³R⁴ | — | —CH2—CH2—NH—CH2—CH2— |

TABLE A

| | |
|---|---|
| A1 | Cl |
| A2 | F |
| A3 | OMe |
| A4 | OEt |
| A5 | OH |
| A6 | Br |
| A7 | I |
| A8 | OCF3 |
| A9 | OCHF2 |
| A10 | Propoxy |

TABLE 1
This table discloses the 161 compounds T2.001 to T2.161 of the formula IA:

| | |
|---|---|
| 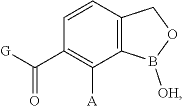 | (IA) |

wherein A is A1 as defined in Table A, and G has the specific meaning given in the corresponding line appropriately selected from the 161 lines T2.001 to T2.161 of Table T2
Table 2: This table discloses the 161 compounds T2.001 to T2.161 of the formula IA, wherein A is A2 as defined in table A, and G has the specific meaning given in the corresponding line appropriately selected from the 161 lines T2.001 to T2.161 of Table T2
Table 3: This table discloses the 161 compounds T2.001 to T2.161 of the formula IA, wherein A is A3 as defined in table A, and G has the specific meaning given in the corresponding line appropriately selected from the 161 lines T2.001 to T2.161 of Table T3
Table 4: This table discloses the 161 compounds T2.001 to T2.161 of the formula IA, wherein A is A4 as defined in table A, and G has the specific meaning given in the corresponding line appropriately selected from the 161 lines T2.001 to T2.161 of Table T4
Table 5: This table discloses the 161 compounds T2.001 to T2.161 of the formula IA, wherein A is A5 as defined in table A, and G has the specific meaning given in the corresponding line appropriately selected from the 161 lines T2.001 to T2.161 of Table T5
Table 6: This table discloses the 161 compounds T2.001 to T2.161 of the formula IA, wherein A is A6 as defined in table A, and G has the specific meaning given in the corresponding line appropriately selected from the 161 lines T2.001 to T2.161 of Table T6
Table 7: This table discloses the 161 compounds T2.001 to T2.161 of the formula IA, wherein A is A7 as defined in table A, and G has the specific meaning given in the corresponding line appropriately selected from the 161 lines T2.001 to T2.161 of Table T7
Table 8: This table discloses the 161 compounds T2.001 to T2.161 of the formula IA, wherein A is A8 as defined in table A, and G has the specific meaning given in the corresponding line appropriately selected from the 161 lines T2.001 to T2.161 of Table T8
Table 9: This table discloses the 161 compounds T2.001 to T2.161 of the formula IA, wherein A is A9 as defined in table A, and G has the specific meaning given in the corresponding line appropriately selected from the 161 lines T2.001 to T2.161 of Table T9
Table 10: This table discloses the 161 compounds T2.001 to T2.161 of the formula IA, wherein A is A10 as defined in table A, and G has the specific meaning given in the corresponding line appropriately selected from the 161 lines T2.001 to T2.161 of Table T10

Surprisingly, it has now been found that the novel compounds of formula I have, for practical purposes, a very advantageous level of biological activity for protecting plants against diseases that are caused by fungi.

The compounds of formula (I) of this invention are useful as plant disease control agents. The present invention therefore further comprises a method for controlling plant diseases caused by fungal plant pathogens comprising applying to the plant or portion thereof to be protected, or to the plant seed to be protected, an effective amount of a compound of the invention or a fungicidal composition containing said compound.

Compounds of formula (I) and fungicidal compositions containing them may be used to control plant diseases caused by a broad spectrum of fungal plant pathogens in the Basidiomycete, Ascomycete, Oomycete and/or Deuteromycete, Blasocladiomycete, Chrytidiomycete, Glomeromycete and/or Mucoromycete classes.

They are effective in controlling a broad spectrum of plant diseases, such as foliar pathogens of ornamental, turf, vegetable, field, cereal, and fruit crops.

These pathogens may include:

Oomycetes, including Phytophthora diseases such as those caused by Phytophthora capsici, Phytophthora infestans, Phytophthora sojae, Phytophthora fragariae, Phytophthora nicotianae, Phytophthora cinnamomi, Phytophthora citricola, Phytophthora citrophthora and Phytophthora erythroseptica; Pythium diseases such as those caused by Pythium aphanidermatum, Pythium arrhenomanes, Pythium graminicola, Pythium irregulare, Pythium sylvaticum and Pythium ultimum; diseases caused by Peronosporales such as Peronospora destructor, Peronospora parasitica, Plasmopara viticola, Plasmopara halstedii, Pseudoperonospora cubensis, Albugo candida, Sclerophthora macrospora and Bremia lactucae; and others such as Aphanomyces cochlioides, Labyrinthula zosterae, Peronosclerospora sorghi and Sclerospora graminicola.

Ascomycetes, including blotch, spot, blast or blight diseases and/or rots for example those caused by Pleosporales such as Stemphylium solani, Stagonospora tainanensis, Spilocaea oleaginea, Setosphaeria turcica, Pyrenochaeta lycoperisici, Pleospora herbarum, Phoma destructiva, Phaeosphaeria herpotrichoides, Phaeocryptocus gaeumannii, Ophiosphaerella graminicola, Ophiobolus graminis, Leptosphaeria maculans, Hendersonia creberrima, Helminthosporium triticirepentis, Setosphaeria turcica, Drechslera glycines, Didymella bryoniae, Cycloconium oleagineum, Corynespora cassiicola, Cochliobolus sativus, Bipolaris cactivora, Venturia inaequalis, Pyrenophora teres, Pyrenophora tritici-repentis, Alternaria altemata, Alternaria brassicicola, Alternaria solani and Alternaria tomatophila, Capnodiales such as Septoria tritici, Septoria nodorum, Septoria glycines, Cercospora arachidicola, Cercospora sojina, Cercospora zeae-maydis, Cercosporella capsellae and Cercosporella herpotrichoides, Cladosporium carpophilum, Cladosporium effusum, Passalora fulva, Cladosporium oxysporum, Dothistroma septosporum, Isariopsis clavispora, Mycosphaerella fijiensis, Mycosphaerella graminicola, Mycovellosiella koepkeii, Phaeoisariopsis bataticola, Pseudocercospora vitis, Pseudocercosporella herpotrichoides, Ramularia beticola, Ramularia collo-cygni, Magnaporthales such as Gaeumannomyces graminis, Magnaporthe grisea, Pyricularia oryzae, Diaporthales such as Anisogramma anomala, Apiognomonia errabunda, Cytospora platani, Diaporthe phaseolorum, Discula destructiva, Gnomonia fructicola, Greeneria uvicola, Melanconium juglandinum, Phomopsis viticola, Sirococcus clavigignenti-juglandacearum, Tubakia dryina, Dicarpella spp., Valsa ceratosperma, and others such as Actinothyrium graminis, Ascochyta pisi, Aspergillus flavus, Aspergillus fumigatus, Aspergillus nidulans, Asperisporium caricae, Blumeriella jaapii, Candida spp., Capnodium ramosum, Cephaloascus spp., Cephalosporium gramineum, Ceratocystis paradoxa, Chaetomium spp., Hymenoscyphus pseudoalbidus, Coccidioides spp., Cylindrosporium padi, Diplocarpon malae, Drepanopeziza campestris, Elsinoe ampelina, Epicoccum nigrum, Epidermophyton spp., Eutypa lata, Geotrichum candidum, Gibellina cerealis, Gloeocercospora sorghi, Gloeodes pomigena, Gloeosporium perennans; Gloeotinia temulenta, Griphospaeria corticola, Kabatiella lini, Leptographium microsporum, Leptosphaerulinia crassiasca, Lophodermium seditiosum, Marssonina graminicola, Microdochium nivale, Monilinia fructicola, Monographella albescens, Monosporascus cannonballus, Naemacyclus spp., Ophiostoma novo-ulmi, Paracoccidioides brasiliensis, Penicillium expansum, Pestalotia rhododendri, Petriellidium spp., Pezicula spp., Phialophora gregata, Phyllachora pomigena, Phymatotrichum omnivora, Physalospora abdita, Plectosporium tabacinum, Polyscytalum pustulans, Pseudopeziza medicaginis, Pyrenopeziza brassicae, Ramulispora sorghi, Rhabdocline pseudotsugae, Rhynchosporium secalis, Sacrocladium oryzae, Scedosporium spp., Schizothyrium pomi, Sclerotinia sclerotiorum, Sclerotinia minor; Sclerotium spp., Typhula ishikariensis, Seimatosporium mariae, Lepteutypa cupressi, Septocyta ruborum, Sphaceloma perseae, Sporonema phacidioides, Stigmina palmivora, Tapesia yallundae, Taphrina bullata, Thielviopsis basicola, Trichoseptoria fructigena, Zygophiala jamaicensis; powdery mildew diseases for example those caused by Erysiphales such as Blumeria graminis, Erysiphe polygoni, Uncinula necator, Sphaerotheca fuligena, Podosphaeraleucotricha, Podospaera macularis Golovinomyces cichoracearum, Leveillula taurica, Microsphaera diffusa, Oidiopsis gossypii, Phyllactinia guttata and Oidium arachidis; molds for example those caused by Botryosphaeriales such as Dothiorella aromatica, Dipodia seriata, Guignardia bidwellii, Botrytis cinerea, Botryotinia allii, Botryotinia fabae, Fusicoccum amygdali, Lasiodiplodia theobromae, Macrophoma theicola, Macrophomina phaseolina, Phyllosticta cucurbitacearum; anthracnoses for example those caused by Glommerelales such as Colletotrichum gloeosporioides, Colletotrichum lagenarium, Colletotrichum gossypii, Glomerella cingulata, and Colletotrichum graminicola; and wilts or blights for example those caused by Hypocreales such as Acremonium strictum, Claviceps purpurea, Fusarium culmorum, Fusarium graminearum, Fusarium virguliforme, Fusarium oxysporum, Fusarium subglutinans, Fusarium oxysporum f. sp. cubense, Gerlachia nivale, Gibberella fujikuroi, Gibberella zeae, Gliocladium spp., Myrothecium verrucaria, Nectria ramulariae, Trichoderma viride, Trichothecium roseum, and Verticillium theobromae.

Basidiomycetes, including smuts for example those caused by Ustilaginales such as Ustilaginoidea virens, Ustilago nuda, Ustilago tritici, Ustilago zeae, rusts for example those caused by Pucciniales such as Cerotelium fici, Chrysomyxa arctostaphyli, Coleosporium ipomoeae, Hemileia vastatrix, Puccinia arachidis, Puccinia cacabata, Puccinia graminis, Puccinia recondita, Puccinia sorghi, Puccinia hordei, Puccinia striiformis f. sp. Hordei, Puccinia striiformis f. sp. Secalis, Pucciniastrum coryli, or Uredinales such as Cronartium ribicola, Gymnosporangium juniperi-viginianae, Melampsora medusae, Phakopsora pachyrhizi, Phragmidium mucronatum, Physopella ampelosidis, Tranzschelia discolor and Uromyces viciae-fabae; and other rots and diseases such as those caused by Cryptococcus spp., Exobasidium vexans, Marasmiellus inoderma, Mycena spp., Sphacelotheca reiliana, Typhula ishikariensis, Urocystis agropyri, Itersonilia perplexans, Corticium invisum, Laetisaria fuciformis, Waitea circinata, Rhizoctonia solani, Thanetephorus cucurmeris, Entyloma dahliae, Entylomella microspora, Neovossia moliniae and Tilletia caries.

Blastocladiomycetes, such as Physoderma maydis.

Mucoromycetes, such as Choanephora cucurbitarum; Mucor spp.; Rhizopus arrhizus,

As well as diseases caused by other species and genera closely related to those listed above.

In addition to their fungicidal activity, the compounds and compositions comprising them may also have activity against bacteria such as Erwinia amylovora, Erwinia caratovora, Xanthomonas campestris, Pseudomonas syringae, Strptomyces scabies and other related species as well as certain protozoa.

Compounds of formula (I) may be mixed with one or more of compounds selected from those in the following chemical or functional classes:—1,2,4-thiadiazoles, 2,6-dinitroanilines, acylalanines, aliphatic nitrogenous compounds, amidines, aminopyrimidinols, anilides, anilino-pyrimidines, anthraquinones, antibiotics, aryl-phenylketones, benzamides, benzene-sulfonamides, benzimidazoles, benzothiazoles, benzothiodiazoles, benzothiophenes, benzoylpyridines, benzthiadiazoles, benzylcarbamates, butylamines, carbamates, carboxamides, carpropamids, chloronitriles, cinnamic acid amides, copper containing compounds, cyanoacetamideoximes, cyanoacrylates, cyanoimidazoles, cyanomethylene-thiazolidines, dicarbonitriles, dicarboxamides, dicarboximides, dimethylsulphamates, dinitrophenol carbonates, dinitrophenysl, dinitrophenyl crotonates, diphenyl phosphates, dithiino compounds, dithiocarbamates, dithioethers, dithiolanes, ethyl-amino-thiazole carboxamides, ethyl-phosphonates, furan carboxamides, glucopyranosyls, glucopyranoxyls, glutaronitriles, guanidines, herbicides/plant growth regulatosr, hexopyranosyl antibiotics, hydroxy(2-amino)pyrimidines, hydroxyanilides, hydroxyisoxazoles, imidazoles, imidazolinones, insecticides/plant growth regulators, isobenzofuranones, isoxazolidinyl-pyridines, isoxazolines, maleimides, mandelic acid amides, mectin derivatives, morpholines, norpholines, n-phenyl carbamates, organotin compounds, oxathiin carboxamides, oxazoles, oxazolidine-diones, phenols, phenoxy quinolines, phenyl-acetamides, phenylamides, phenylbenzamides, phenyl-oxo-ethyl-thiophenes amides, phenylpyrroles, phenylureas, phosphorothiolates, phosphorus acids, phthalamic acids, phthalimides, picolinamides, piperazines, piperidines, plant extracts, polyoxins, propionamides, pthalimides, pyrazole-4-carboxamides, pyrazolinones, pyridazinones, pyridines, pyridine carboxamides, pyridinyl-ethyl benzamides, pyrimdinamines, pyrimidines, pyrimidine-amines, pyrimidione-hydrazone, pyrrolidines, pyrrolquinoliones, quinazolinones, quinolines, quinoline derivatives, quinoline-7-carboxylic acids, quinoxalines, spiroketalamines, strobilurins, sulfamoyl triazoles, sulphamides, tetrazolyloximes, thiadiazines, thiadiazole carboxamides, thiazole carboxanides, thiocyanates, thiophene carboxamides, toluamides, triazines, triazobenthiazoles, triazoles, triazole-thiones, triazolo-pyrimidylamine, valinamide carbamates, ammonium methyl phosphonates, arsenic-containing compounds, benyimidazolylcarbamates, carbonitriles, carboxanilides, carboximidamides, carboxylic phenylamides, diphenyl pyridines, furanilides, hydrazine carboxamides, imidazoline acetates, isophthalates, isoxazolones, mercury salts, organomercury compounds, organophosphates, oxazolidinediones, pentylsulfonyl benzenes, phenyl benzamides, phosphonothionates, phosphorothioates, pyridyl carboxamides, pyridyl furfuryl ethers, pyridyl methyl ethers, SDHls, thiadiazinanethiones, thiazolidines.

Particularly preferred fungicidal combinations include the following where “I” designates compounds of formula (I): I+(.+/−.)-cis-1-(4-chlorophenyl)-2-(1H-1,2,4-triazol-1-yl)-cycloheptanol (huanjunzuo), I+(2RS)-2-bromo-2-(bromomethyl)glutaronitrile (bromothalonil), I+(E)-N-methyl-2-[2-(2, 5-dimethylphenoxymethyl) phenyl]-2-methoxy-iminoacetamide, (mandestrobin), I+1-(5-bromo-2-pyridyl)-2-(2,4-difluorophenyl)-1,1-difluoro-3-(1,2,4-triazol-1-yl)propan-2-ol, I+1-methylcyclopropene, I+2-methyl-, [[4-methoxy-2-[[[(3S,7R, 8R,9S)-9-methyl-8-(2-methyl-1-oxopropoxy)-2,6-dioxo-7-(phenylmethyl)-1,5-dioxonan-3-yl]amino]carbonyl]-3-pyridinyl]oxy]propanoic acid methyl ester, I+2-(1-tert-butyl)-1-(2-chlorophenyl)-3-(1,2,4-triazol-1-yl)-propan-2-ol (TCDP), I+2,4-D, I+2,4-DB, I+2,6-dichloro-N-(4-trifluoromethylbenzyl)-benzamide, I+2,6-dimethyl-[1,4]dithiino[2,3-c:5,6-c]dipyrrole-1,3,5,7(2H,6H)-tetraone, I+2-[[(1R,5S)-5-[(4-fluorophenyl)methyl]-1-hydroxy-2,2-dimethyl-cyclopentyl]methyl]-4H-1,2,4-triazole-3-thione I+2-[[3-(2-chlorophenyl)-2-(2,4-difluorophenyl)oxiran-2-yl]methyl]-4H-1,2,4-triazole-3-thione I+ametoctradin (imidium), I+2-[2-[(7,8-difluoro-2-methyl-3-quinolyl)oxy]-6-fluoro-phenyl]propan-2-ol I+2-[2-fluoro-6-[(8-fluoro-2-methyl-3-quinolyl)oxy]phenyl]propan-2-ol I+cyflufenamid, I+2-benzyl-4-chlorophenol (Chlorophene), I+3-(difluoromethyl)-N-(7-fluoro-1,1,3,3-tetramethyl-indan-4-yl)-1-methyl-pyrazole-4-carboxamide I+diclocymet, I+3-(difluoromethyl)-N-methoxy-1-methyl-N-[1-methyl-2-(2,4,6-trichlorophenyl)ethyl]pyrazole-4-carboxamide, I+3′-chloro-2-methoxy-N-[(3RS)-tetrahydro-2-oxofuran-3-yl]acet-2′,6′-xylidide (clozylacon), I+3-iodo-2-propinyl n-butylcarbamate (IPBC), I+4,4,5-trifluoro-3,3-dimethyl-1-(3-quinolyl)isoquinoline I+4,4-difluoro-3,3-dimethyl-1-(3-quinolyl)isoquinoline I+5-fluoro-3,3,4,4-tetramethyl-1-(3-quinolyl)isoquinoline I+9-fluoro-2,2-dimethyl-5-(3-quinolyl)-3H-1,4-benzoxazepine I+tebufloquin, I+4-CPA, I+5-fluoro-2-(p-tolylmethoxy)pyrimidin-4-amine I+ferimzone, I+acibenzolar, I+acibenzolar-S-methyl, I+allyl alcohol, I+ametoctradin, I+amisulbrom, I+anilazine, I+aureofungin, I+azaconazole, I+azafenidin, I+azithiram, I+azoxystrobin, I+benalaxyl, I+benalaxyl-M, I+benalaxyl-M (kiralaxyl), I+benomyl, I+benthiavalicarb, I+benthiazole (TCMTB), I+benzalkonium chloride, I+benzamorf, I+benzovindiflupyr (solatenol), I+bethoxazin, I+biphenyl, I+bitertanol (biloxazol), I+bixafen, I+BLAD, I+blasticidin-S, I+Bordeaux mixture, I+boscalid, I+bromuconazole, I+bupirimate, I+but-3-ynyl N-[6-[[(Z)-[(1-methyltetrazol-5-yl)-phenyl-methylene]amino]oxymethyl]-2-pyridyl]carbamate I+dazomet, I+butylamine, I+calcium polysulfide, I+captafol, I+captan, I+carbaryl, I+carbendazim, I+carbendazim chlorhydrate, I+carboxin, I+CAS 517875-34-2 (DAS777), I+chinomethionate, I+chinomethionate (oxythioquinox, quinoxymethionate), I+chitosan, I+chlobenthiazone, I+chlorfenazole, I+chlormequat, I+chloroneb, I+chloropicrin, I+chlorothalonil, I+chlozolinate, I+climbazole, I+clofencet, I+copper acetate, I+copper carbonate, I+copper hydroxide, I+copper naphthenate, I+copper oleate, I+copper oxychloride, I+copper oxyquinolate, I+copper silicate, I+copper sulphate, I+copper tallate, I+coumoxystrobin, I+cresol, I+cuprous oxide, I+cyazofamid, I+cyclafuramid, I+cymoxanil, I+cyproconazole, I+cyprodinil, I+daracide, I+dichlofluanid, I+dichlorophen (dichlorophene), I+dichlorprop, I+diclomezine, I+dicloran, I+diethofencarb, I+difenoconazole, I+difenzoquat, I+diflumetorim, I+dimetachlone (dimethaclone), I+dimetconazole, I+dimethipin, I+dimethirimol, I+dimethomorph, I+dimoxystrobin, I+dingjunezuo (Jun Si Qi), I+diniconazole, I+diniconazole-M, I+, I+dinobuton, I+dinocap, I+dinocton, I+dinopenton, I+diphenylamine, I+dipyrithione, I+ditalimfos, I+dithianon, I+dithioether, I+dodemorph, I+dodicin, I+dodine, I+doguadine, I+drazoxolon, I+edifenphos, I+endothal, I+enestroburin, enoxastrobin I+fenamistrobin, I+epoxiconazole, I+etaconazole, I+etem, I+ethaboxam, I+ethephon, I+ethoxyquin, I+famoxadone, I+fenamidone, I+fenarimol, I+fenbuconazole, I+fenfuram, I+fenhexamid, I+fenoxanil, I+fenpiclonil, I+fenpropidin, I+fenpropimorph, I+fenpyrazamine, I+fentin acetate, I+fentin hydroxide, I+ferbam, I+fluazinam, I+fludioxonil, I+flufenoxystrobin, I+flumetralin, I+flumorph, I+fluopicolide, I+fluopicolide (flupicolide), I+fluopyram, I+fluoroimide, I+fluoxastrobin, I+fluquinconazole, I+flusilazole, I+flusulfamide, I+flutianil, I+flutolanil, I+flutriafol, I+fluxapyroxad, I+folpet, I+forchlorfenuron, I+fosetyl, I+fuberidazole, I+furalaxyl, I+furametpyr, I+gibberellic acid, I+gibberellins, I+guazatine, I+hexachlorobenzene, I+hexaconazole, I+hymexazol, I+hymexazole, hydroxyisoxazole I+imazalil, I+I+etridiazole, I+imazalil, I+imazalil sulphate, I+imibenconazole, I+iminoctadine, I+iminoctadine triacetate, I+iodocarb (isopropanyl butylcarbamate), I+ipconazole, I+iprobenfos, I+iprodione, I+iprovalicarb, I+isofetamid, I+isopropanyl butylcarbamate (iodocarb), I+isoprothiolane, I+isopyrazam, I+isotianil, I+kasugamycin, I+kresoxim-methyl, I+KSF-1002, I+maleic hydrazide, I+mancozeb, I+mandestrobin, I+mandipropamid, I+maneb, I+mepanipyrim, I+mepiquat, I+mepronil, I+meptyldinocap, I+metalaxyl, I+metalaxyl-M (mefenoxam), I+metam, I+metaminostrobin, I+metconazole, I+methyl bromide, I+methyl iodide, I+methyl isothiocyanate, I+metiram (polyram), I+metiram-zinc, I+metominostrobin, I+metrafenone, I+m-phenylphenol, I+myclobutanil, I+N′-(2,5-Dimethyl-4-phenoxy-phenyl)-N-ethyl-N-methyl-formamidine, I+N′-[4-(4,5-Dichloro-thiazol-2-yloxy)-2,5-dimethyl-phenyl]-N-ethyl-N-methyl-formamidine, I+N′-[4-[[3-[(4-chlorophenyl)methyl]-1,2,4-thiadiazol-5-yl]oxy]-2,5-dimethyl-phenyl]-N-ethyl-N-methyl-formamidine, I+ethirimol, I+N-(2-p-chlorobenzoylethyl)-hexaminium chloride, I+N-[(5-chloro-2-isopropyl-phenyl)methyl]-N-cyclopropyl-3-(difluoromethyl)-5-fluoro-1-methyl-pyrazole-4-carboxamide I+N-cyclopropyl-3-(difluoromethyl)-5-fluoro-N-[(2-isopropylphenyl)methyl]-1-methyl-pyrazole-4-carboxamide I+carpropamid, I+nabam, I+naphthalene acetamide, I+NNF-0721, I+octhilinone, I+ofurace, I+orysastrobin, I+osthol, I+oxadixyl, I+oxasulfuron, I+oxathiapiprolin, I+oxine-copper, I+oxolinic acid, I+oxpoconazole, I+oxycarboxin, I+paclobutrazol, I+pefurazoate, I+penconazole, I+pencycuron, I+penflufen, I+penthiopyrad, I+phenamacril, I+phosdiphen, I+phosetyl-AI, I+phosetyl-AI (fosetyl-al), I+phosphorus acids, I+phthalide (fthalide), I+picarbutrazox, I+picoxystrobin, I+piperalin, I+polycarbamate, I+polyoxin D (polyoxrim), I+p-phenylphenol, I+probenazole, I+prochloraz, I+procymidone, I+prohexadione, I+prohexadione-calcium, I+propamidine, I+propamocarb, I+propiconazole, I+propineb, I+propionic acid, I+proquinazid, I+prothioconazole, I+pyraclostrobin, I+pyrametostrobin, I+pyraoxystrobin, I+pyrazophos, I+pyribencarb (KIF-7767), I+pyrifenox, I+pyrimethanil, I+pyriofenone (IKF-309), I+pyroquilon, I+quinoxyfen, I+quintozene, I+sedaxane, I+silthiofam, I+simeconazole, I+spiroxamine, I+streptomycin, I+sulphur, I+tebuconazole, I+tebufloquin, I+tecloftalam, I+tecnazene, (TCNB), I+tetraconazole, I+thiabendazole, I+thicyofen, I+thidiazuron, I+thifluzamide, I+thiophanate-methyl, I+thiram, I+tiadinil, I+tioxymid, I+tolclofos-methyl, I+tolprocarb, I+tolylfluanid, I+triadimefon, I+triadimenol, I+triazoxide, I+tribromophenol (TBP), I+tribufos (tributyl phosphorotrithioate), I+triclopyricarb, I+tricyclazole, I+tridemorph, I+trifloxystrobin, I+triflumizole, I+triforine, I+trinexapac, I+triticonazole, I+uniconazole, I+validamycin, I+valifenalate, I+vapam, I+vapam (metam sodium), I+vinclozolin, I+zineb, I+ziram, I+zoxamide, I+α-naphthalene acetic acid.

Compounds of this invention can also be mixed with one or more further pesticides including insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection.

Examples of such agricultural protectants with which compounds of this invention can be formulated are:

Insecticides such as abamectin, acephate, acetamiprid, amidoflumet (S-1955), avermectin, azadirachtin, azinphos-methyl, bifenthrin, bifenazate, buprofezin, carbofuran, cartap, chlorantraniliprole (DPX-E2Y45), chlorfenapyr, chlorfluazuron, chlorpyrifos, chlorpyrifos-methyl, chromafenozide, clothianidin, cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, metaflumizone, metaldehyde, methamidophos, methidathion, methomyl, methoprene, methoxychlor, metofluthrin, monocrotophos, methoxyfenozide, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulprofos, tebufenozide, teflubenzuron, tefluthrin, terbufos, tetrachlorvinphos, thiacloprid, thiamethoxam, thiodicarb, thiosultap-sodium, tralomethrin, triazamate, trichlorfon and triflumuron; Bactericides such as streptomycin;

Acaricides such as amitraz, chinomethionat, chlorobenzilate, cyenopyrafen, cyhexatin, dicofol, dienochlor, etoxazole, fenazaquin, fenbutatin oxide, fenpropathrin, fenpyroximate, hexythiazox, propargite, pyridaben and tebufenpyrad; and

Biological agents such as Bacillus thuringiensis, Bacillus thuringiensis delta endotoxin, baculovirus, and entomopathogenic bacteria, virus and fungi.

Plant disease control is ordinarily accomplished by applying an effective amount of a compound of this invention either pre- or post-infection, to the portion of the plant to be protected such as the roots, stems, foliage, fruit, seeds, tubers or bulbs, or to the media (soil or sand) in which the plants to be protected are growing. The compounds may also be applied to seeds to protect the seeds and seedlings developing from the seeds. The compounds may also be applied through irrigation water to treat plants.

The present invention envisages application of the compounds of the invention to plant propagation material prior to, during, or after planting, or any combination of these.

Although active ingredients can be applied to plant propagation material in any physiological state, a common approach is to use seeds in a sufficiently durable state to incur no damage during the treatment process. Typically, seed would have been harvested from the field; removed from the plant; and separated from any cob, stalk, outer husk, and surrounding pulp or other non-seed plant material. Seed would preferably also be biologically stable to the extent that treatment would not cause biological damage to the seed. It is believed that treatment can be applied to seed at any time between seed harvest and sowing of seed including during the sowing process.

Methods for applying or treating active ingredients on to plant propagation material or to the locus of planting are known in the art and include dressing, coating, pelleting and soaking as well as nursery tray application, in furrow application, soil drenching, soil injection, drip irrigation, application through sprinklers or central pivot, or incorporation into soil (broad cast or in band). Alternatively or in addition active ingredients may be applied on a suitable substrate sown together with the plant propagation material.

Rates of application for these compounds can be influenced by many factors of the environment and should be determined under actual use conditions. Foliage can normally be protected when treated at a rate of from less than about 1 g/ha to about 5,000 g/ha of active ingredient. Seed and seedlings can normally be protected when seed is treated at a rate of from about 0.1 to about 10 g per kilogram of seed.

Crops of useful plants in which the composition according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes.

Crops are to be understood as being those which are naturally occurring, obtained by conventional methods of breeding, or obtained by genetic engineering. They include crops which contain so-called output traits (e.g. improved storage stability, higher nutritional value and improved flavour).

Crops are to be understood as also including those crops which have been rendered tolerant to herbicides like bromoxynil or classes of herbicides such as ALS-, EPSPS-, GS-, HPPD- and PPO-inhibitors. An example of a crop that has been rendered tolerant to imidazolinones, e.g. imazamox, by conventional methods of breeding is Clearfield® summer canola. Examples of crops that have been rendered tolerant to herbicides by genetic engineering methods include e.g. glyphosate- and glufosinate-resistant maize varieties commercially available under the trade names RoundupReady®, Herculex I® and LibertyLink®.

Crops are also to be understood as being those which naturally are or have been rendered resistant to harmful insects. This includes plants transformed by the use of recombinant DNA techniques, for example, to be capable of synthesising one or more selectively acting toxins, such as are known, for example, from toxin-producing bacteria. Examples of toxins which can be expressed include δ-endotoxins, vegetative insecticidal proteins (Vip), insecticidal proteins of bacteria colonising nematodes, and toxins produced by scorpions, arachnids, wasps and fungi.

An example of a crop that has been modified to express the Bacillus thuringiensis toxin is the Bt maize KnockOut® (Syngenta Seeds). An example of a crop comprising more than one gene that codes for insecticidal resistance and thus expresses more than one toxin is VipCot® (Syngenta Seeds). Crops or seed material thereof can also be resistant to multiple types of pests (so-called stacked transgenic events when created by genetic modification). For example, a plant can have the ability to express an insecticidal protein while at the same time being herbicide tolerant, for example Herculex I® (Dow AgroSciences, Pioneer Hi-Bred International).

The compounds according to the invention can be used as pesticidal agents in unmodified form, but they are generally formulated into compositions in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents.

The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood N.J. (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of

Herbicide Adjuvants, 10^{th} Edition, Southern Illinois University, 2010.

The inventive compositions generally comprise from 0.1 to 99% by weight, especially from 0.1 to 95% by weight, of compounds of the present invention and from 1 to 99.9% by weight of a formulation adjuvant which preferably includes from 0 to 25% by weight of a surface-active substance. Whereas commercial products may preferably be formulated as concentrates, the end user will normally employ dilute formulations.

The rates of application vary within wide limits and depend on the nature of the soil, the method of application, the crop plant, the pest to be controlled, the prevailing climatic conditions, and other factors governed by the method of application, the time of application and the target crop. As a general guideline compounds may be applied at a rate of from 1 to 2000 I/ha, especially from 10 to 1000 I/ha.

Preferred formulations can have the following compositions (weight %):

### Emulsifiable Concentrates:

active ingredient: 1 to 95%, preferably 60 to 90%
surface-active agent: 1 to 30%, preferably 5 to 20%
liquid carrier: 1 to 80%, preferably 1 to 35%

### Dusts:

active ingredient: 0.1 to 10%, preferably 0.1 to 5%
solid carrier: 99.9 to 90%, preferably 99.9 to 99%

### Suspension Concentrates:

active ingredient: 5 to 75%, preferably 10 to 50%
water: 94 to 24%, preferably 88 to 30%
surface-active agent: 1 to 40%, preferably 2 to 30%

### Wettable Powders:

active ingredient: 0.5 to 90%, preferably 1 to 80%
surface-active agent: 0.5 to 20%, preferably 1 to 15%
solid carrier: 5 to 95%, preferably 15 to 90%

### Granules:

active ingredient: 0.1 to 30%, preferably 0.1 to 15%
solid carrier: 99.5 to 70%, preferably 97 to 85%

The following Examples further illustrate, but do not limit, the invention.

| Wettable powders | a) | b) | c) |
|---|---|---|---|
| active ingredient | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredient | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

| Emulsifiable concentrate | |
|---|---|
| active ingredient | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| Cyclohexanone | 30% |
| Xylene mixture | 50% |

Emulsions of any required dilution, which can be used in plant protection, can be obtained from this concentrate by dilution with water.

| Dusts | a) | b) | c) |
|---|---|---|---|
| Active ingredient | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

| Extruded granules | |
|---|---|
| Active ingredient | 15% |
| sodium lignosulfonate | 2% |
| carboxymethylcellulose | 1% |
| Kaolin | 82% |

The combination is mixed and ground with the adjuvants, and the mixture is moistened with water. The mixture is extruded and then dried in a stream of air.

| Coated granules | |
|---|---|
| Active ingredient | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

Suspension Concentrate

| | |
|---|---|
| active ingredient | 40% |
| propylene glycol | 10% |
| nonylphenol polyethylene glycol ether (15 mol of ethylene oxide) | 6% |
| Sodium lignosulfonate | 10% |
| carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable Concentrate for Seed Treatment

| | |
|---|---|
| active ingredient | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution | 0.5% |
| in water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Slow Release Capsule Suspension

28 parts of the combination are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

The Examples which follow serve to illustrate the invention. The compounds of the invention can be distinguished from known compounds by virtue of greater efficacy at low application rates, which can be verified by the person skilled in the art using the experimental procedures outlined in the Examples, using lower application rates if necessary, for example 50 ppm, 12.5 ppm, 6 ppm, 3 ppm, 1.5 ppm or 0.8 ppm.

### PREPARATION EXAMPLES

### Example 1: Preparation of 2-chloro-3,6-dimethyl-phenol

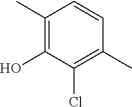

To a solution of 2,5-dimethylphenol (10 g, 81.8552 mmol) and 2,2,6,6-tetramethylpiperidine (1.15 gm, 8.1855 mmol) in toluene (600 mL, 60 mL/g) at 100° C. was added SO₂Cl₂ (12.4 g, 90.0407 mmol) slowly under nitrogen and refluxed for one hour. The reaction mass was cooled to ambient temperature and toluene was evaporated under reduced pressure. The residual mass was dissolved in 50 ml CH₂Cl₂ and was washed with water. Organic layer was finally dried over sodium sulfate and evaporated to dryness to obtain 2-chloro-3,6-dimethyl-phenol (8 g, 51.0817 mmol, 62.4049% Yield) as a white solid.

¹H NMR (400 MHz, DMSO-d₆) δ ppm 2.17 (s, 3H) 2.26 (s, 3H) 6.72 (d, J=7.58 Hz, 1H) 6.94 (d, J=7.58 Hz, 1H) 8.89 (s, 1H)

MS [M−H]⁻: 155.26 (rt 1.34)

### Example P2: Preparation of 2-chloro-3-methoxy-1,4-dimethyl-benzene

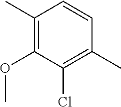

To a solution of 2-chloro-3,6-dimethyl-phenol, P1 (2.5 g, 16 mmol) in Acetone (20 mL, 8 mL/g) was added potassium carbonate (2.7 gm, 19 mmol) followed by iodomethane (2.5 gm, 1.1 equiv., 18 mmol). Then reaction mixture was refluxed overnight at 60° C.

Reaction mixture was then concentrated and diluted with water (30 ml). The aqueous layer was extracted with ethyl acetate (3×20 ml). Combined organic layer was dried over sodium sulphate and concentrated to obtain the crude mass. This crude mass thus obtained was purified by flash chromatography using 10% ethyl acetate in hexane as eluent to afford desired compound. compound 2-chloro-3-methoxy-1,4-dimethyl-benzene (2.7 g, 92% yield) as white solid

1H NMR (400 MHz, DMSO-d6) δ ppm 2.30 (s, 3H) 2.36 (s, 3H) 3.82 (s, 3H) 6.72 (d, J=7.58 Hz, 1H) 6.94 (d, J=7.58 Hz, 1H)

MS [M+H]⁺: 171.3 (rt 1.58)

### Example P3: Preparation of 2-chloro-3-methoxy-terephthalic acid

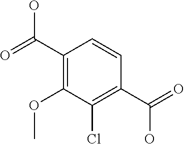

To a solution of 2-chloro-3-methoxy-1,4-dimethyl-benzene, P2 (6 g, 35.162 mmol) in water (240 ml) was added potassium permanganate (22.5 g, 140.65 mmol) in portions at ambient temperature. The reaction mass was heated at 70° C. for 12 h. The dark coloured reaction mass was cooled to room temperature and acidified to pH 2 using 2N HCl. Aqueous solution extracted with ethyl acetate (3×100 ml). Combined organic layers were dried over sodium sulfate and evaporated under reduced pressure. The crude was subject to flash chromatography over silicagel with cyclohexane/ethyl acetate 85:15 to 50:50 as eluent to obtain 2-chloro-3-methoxy-terephthalic acid (2.5 g, 31% of theoretical yield) as a white solid.

¹H NMR (400 MHz, DMSO-d6) δ ppm 3.83 (s, 3H) 7.53 (d, J=8 Hz, 1H) 7.71 (d, J=8 Hz, 1H), 13.48 (m, 2H)

MS [M−H]⁻: 229.36 (rt 0.30)

### Example P4: Preparation of 2-chloro-3-hydroxy-terephthalic acid

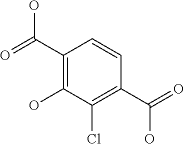 [SMILES: O=C(O)c1ccc(C(=O)O)c(Cl)c1O]

To a solution of 2-chloro-3-methoxy-terephthalic acid, P3 (5 g, 21.683 mmol) in dichloromethane (200 mL, 40 mL/g) maintained at −78° C. was added BBr₃ (1 mol/L) in dichloromethane (43 mL, 43.365 mmol). The reaction mixture was stirred at ambient temperature for 2 hrs. Reaction mixture was then quenched by drop wise addition of saturated sodium bicarbonate solution and the organic layer was separated. The aqueous layer was acidified with 1N HCl and extracted with ethyl acetate (3×25 ml). Combined organic layer thus obtained was then dried over sodium sulfate and concentrated to get the desired product. 2-chloro-3-hydroxy-terephthalic acid (4.2 g, 19 mmol, 89% Yield) as a solid

¹H NMR (400 MHz, DMSO-d6) δ ppm 7.00 (d, J=8.03 Hz, 1H) 7.72 (d, J=8.03 Hz, 1H) 13.50 (m, 1H) MS [M−H]⁺: 215.30 (rt 0.31)

### Example P5: Preparation of dimethyl 2-chloro-3-hydroxy-benzene-1,4-dicarboxylate

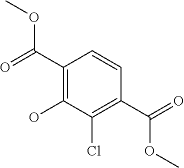 [SMILES: COC(=O)c1ccc(C(=O)OC)c(Cl)c1O]

To a solution of 2-chloro-3-hydroxy-terephthalic acid P4 (1 g, 4.6172 mmol) in methanol (15 mL) at 0° C. was added sulfuric acid (1 mL, 100 mass %). The reaction mixture was then refluxed overnight. The reaction mixture was cooled to ambient temperature and solvents were evaporated off. The residual mass was diluted with water 30 ml and extracted with ethyl acetate (3×20 ml). The combined organic layer was then washed with sodium bicarbonate solution (15 ml), followed by water (2×15 ml), dried over sodium sulphate and concentrated to obtain the desired product dimethyl 2-chloro-3-hydroxy-benzene-1,4-dicarboxylate (750 mg, 3.0659 mmol, 66.4% of theoretical yield) as a white solid

¹H NMR (400 MHz, CHLOROFORM-d) δ ppm 3.99 (m, 6H) 7.26 (m, 1H) 7.83 (d, J=8.31 Hz, 1H) 11.51 (s, 1H) MS [M+H]+: 245.29 (rt 1.33)

### Example P6: Preparation of dimethyl 2-chloro-3-methoxy-benzene-1,4-dicarboxylate

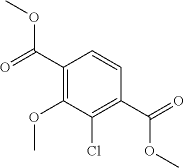 [SMILES: COC(=O)c1ccc(C(=O)OC)c(OC)c1Cl]

To a solution of 2-chloro-3-methoxy-terephthalic acid, P3 (1.7 g, 7.4 mmol) in methanol (26 ml, 15 mL/g) at 0° C. was added sulfuric acid (3.4 mL, 2 mL/g). The reaction mixture was then refluxed overnight. The reaction mixture was cooled to ambient temperature and solvents were evaporated off. The residual mass was diluted with water 30 ml and extracted with ethyl acetate (3×20 ml). The combined organic layer was then washed with sodium bicarbonate solution (15 ml), followed by water (2×15 ml), dried over sodium sulphate and concentrated to obtain the desired product dimethyl 2-chloro-3-methoxy-benzene-1,4-dicarboxylate (1.62 g, 6.26 mmol, 85% of theoretical yield) as a white solid

¹H NMR (400 MHz, DMSO-d6) δ ppm 3.86 (s, 3H) 3.89 (s, 6H) 7.60 (d, J=8.19 Hz, 1H) 7.76 (d, J=8.19 Hz, 1H)

LC MS [M+H]+: 259.32 (rt 1.29)

### Example P7: Preparation of dimethyl 2-methoxy-3-(4,4,5,5-tetramethyl-1,3,2-dioxaborolan-2-yl)benzene-1,4-dicarboxylate

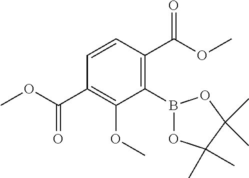

To a stirred solution of dimethyl 2-chloro-3-methoxy-benzene-1,4-dicarboxylate, P6 (0.65 g, 2.5 mmol) in 1,4 dioxane (9.3 mL) was added fused potassium acetate (0.62 g, 6.3 mmol), tricyclohexylphosphine (0.11 g, 0.16 equiv., 0.40 mmol), followed by 4,4,5,5-tetramethyl-2-(4,4,5,5-tetramethyl-1,3,2-dioxaborolan-2-yl)-1,3,2-dioxaborolane (1.6 gm, 6.3 mmol) and finally Tris(dibenzylideneacetone)dipalladium(0) (0.09 gm, 0.04 equiv., 0.10 mmol) under nitrogen. The reaction mixture was irradiated in microwave for 40 min at 140° C. The reaction mixture was cooled to ambient temperature and diluted with water (10 mL) and then extracted with ethyl acetate (3×20 mL). Combined organic layer was washed with water (3×20 mL) followed by brine wash (20 mL). Organic layer was dried over sodium sulfate, filtered and evaporated completely to give crude compound. This crude mass thus obtained was purified by flash chromatography using 10% ethyl acetate in hexane as eluent to afford desired compound dimethyl 2-methoxy-3-(4,4,5,5-tetramethyl-1,3,2-dioxaborolan-2-yl)benzene-1,4-dicarboxylate (0.5 g, 60% of theoretical yield).

¹H NMR (400 MHz, CDCl3-d) δ ppm 1.46 (s, 12H) 3.92 (m, 9H) 7.77 (d, J=7.68 Hz, 1H) 7.86 (d, J=7.68 Hz, 1H)

### Example P8: Preparation of methyl 1-hydroxy-7-methoxy-3H-2,1-benzoxaborole-6-carboxylate

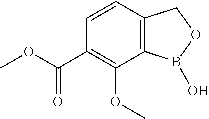 [SMILES: COC(=O)c1ccc2c(c1OC)B(O)OC2]

To a stirred solution of dimethyl 2-methoxy-3-(4,4,5,5-tetramethyl-1,3,2-dioxaborolan-2-yl)benzene-1,4-dicarboxylate, P7 (0.17 g, 0.4855 mmol) in methanol (1.7 mL, 10 mL/g) was added sodium borohydride (0.034 g, 0.9709 mmol) in portions at 0° C. The reaction mixture was then allowed to stir at ambient temperature for 12 h. The reaction mixture was diluted with water (10 mL) followed by acetone (10 mL) and evaporated under reduced pressure. The residual mass was diluted with 2N HCl to pH 2 and stirred for 4 h. The reaction mixture was then extracted with ethyl acetate (3×20 mL). Combined organic layer was washed with water (3×20 mL) followed by brine wash (20 mL). Organic layer was dried over sodium sulfate, filtered and evaporated completely to give crude compound. This crude mass thus obtained was purified by flash chromatography using 10% ethyl acetate in hexane as eluent to afford desired compound methyl 1-hydroxy-7-methoxy-3H-2,1-benzoxaborole-6-carboxylate (0.05 g, 0.2252 mmol, 46% of theoretical yield) as a white solid.

¹H NMR (DMSO-d6, 400 MHz): δ (ppm) 9.32 (s, 1H), 7.69 (d, J=7.8 Hz, 1H), 7.11 (d, J=7.8 Hz, 1H), 5.01 (s, 2H), 4.00 (s, 3H), 3.79-3.83 (s, 3H).

LC-MS [M−H]⁻: 220.9 (RT; 1.38)

### Example P9: Preparation of 1-hydroxy-7-methoxy-3H-2,1-benzoxaborole-6-carboxylic acid

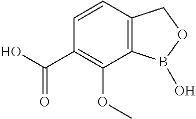

To a stirred solution of methyl 5-chloro-1-hydroxy-3H-2,1-benzoxaborole-6-carboxylate, P8 (5 g, 22.08 mmol) in water (200 mL, 40 mL/g) was added sodium hydroxide (1.35 g, 33.13 mmol) dissolved in 10 ml water. Reaction mass was stirred at 50° C. for 12 h. The reaction mixture was cooled to 0-10° C. and diluted with 2N HCl to pH 2. Precipitation of fine white solid occurred, which was collected by filtration and washed with water and dried under vacuum to afford 1-hydroxy-7-methoxy-3H-2,1-benzoxaborole-6-carboxylic acid (4.2 g, 92% of theoretical yield) as a white solid.

¹H NMR (DMSO-d6, 400 MHz): δ (ppm) 12.61 (br. s., 1H), 9.29 (s, 1H), 7.69 (d, J=7.5 Hz, 1H), 7.09 (d, J=7.7 Hz, 1H), 4.99 (s, 2H), 3.99 (s, 3H).

MS [M+H]⁺: 209.27 (rt 0.27 min)

### Example P10: Preparation of dimethyl 2-chloro-3-(trifluoromethylsulfonyloxy)benzene-1,4-dicarboxylate

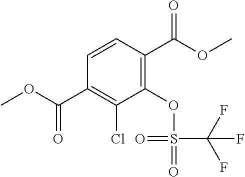 [SMILES: COC(=O)c1ccc(C(=O)OC)c(OS(=O)(=O)C(F)(F)F)c1Cl]

To a stirred solution of dimethyl 2-chloro-3-hydroxy-benzene-1,4-dicarboxylate, P5 (0.7 g, 3 mmol) in anhydrous CH₂Cl₂ (4 mL, 5 mL/g) and pyridine (0.9 mL, 9 mmol) under nitrogen at 0° C. was added

TRIFLIC ANHYDRIDE (0.7 mL, 4 mmol) drops. The reaction mass was allowed to stir for 30 mins at 0° C. and then at ambient temperature for 1 hr. The reaction mixture was then diluted with ethyl acetate (20 mL) and washed with water (3×10 mL), 1N HCl (10 mL) and finally using saturated NaCl solution (10 mL). Organic layer was dried over sodium sulfate, filtered and evaporated completely to obtain the desired compound as brownish thick oil dimethyl 2-chloro-3-(trifluoromethylsulfonyloxy)benzene-1,4-dicarboxylate (0.8 g, 2 mmol, 70% Yield)

¹H NMR (400 MHz, DMSO-d₆) δ ppm 3.90 (m, 6H) 8.06 (m, 2H)

### Example P11: Preparation of dimethyl 2-chloro-3-(4,4,5,5-tetramethyl-1,3,2-dioxaborolan-2-yl)benzene-1,4-dicarboxylate

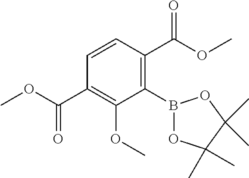

To a stirred solution of dimethyl 2-chloro-3-[hydroxy-dioxo-(trifluoromethyl)-7}-sulfanyl] benzene-1,4-dicarboxylate, P10 (0.8 g, 2 mmol) in 1,4 dioxane (8 mL, 10 mL/g) was added fused potassium acetate (0.6 g, 6.06 mmol), 4,4,5,5-tetramethyl-2-(4,4,5,5-tetramethyl-1,3,2-dioxaborolan-2-yl)-1,3,2-dioxaborolane (0.6 g, 3 mmol) and finally [1,1′-Bis(diphenylphosphino) ferrocene]-dichloropalladium(11) dichloromethane adduct (0.09 g, 0.1 mmol) under nitrogen. The reaction mixture was heated at 100° C. for 3 h. The reaction mixture was cooled to ambient temperature and diluted with water (10 mL) and then extracted with ethyl acetate (3×20 mL). Combined organic layer was washed with water (3×20 mL) followed by brine wash (20 mL). Organic layer was dried over sodium sulfate, filtered and evaporated completely to give crude compound. This crude obtained was purified by flash chromatography using 10% ethyl acetate in hexane as eluent to afford desired compound dimethyl 2-chloro-3-(4,4,5,5-tetramethyl-1,3,2-dioxaborolan-2-yl)benzene-1,4-dicarboxylate (0.3 g, 0.8 mmol, 40% of theoretical yield).

¹H NMR (400 MHz, DMSO-d₆) δ ppm 1.37 (s, 12H) 3.89 (m, 6H) 7.87 (d, J=7.68 Hz, 1H) 7.99 (d, J=7.42 Hz, 1H)

### Example P12: Preparation of methyl 7-chloro-1-hydroxy-3H-2,1-benzoxaborole-6-carboxylate

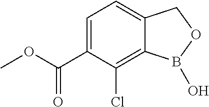

To a stirred solution of dimethyl 2-chloro-3-(4,4,5,5-tetramethyl-1,3,2-dioxaborolan-2-yl)benzene-1,4-dicarboxylate, P11 (300 mg, 0.8460 mmol) in methanol (3 mL, 10 mL/g) was added sodium borohydride (0.065 g, 1.692 mmol) in portions at 0° C. The reaction mixture was then allowed to stir at ambient temperature for 2 h. The reaction mixture was diluted with water (10 mL) followed by acetone (10 mL) and evaporated under reduced pressure. The residual mass was diluted with 2N HCl to pH 2 and stirred for 4 h. Precipitation of fine white solid occurred, which was collected by filtration and washed with water and dried under vacuum to afford methyl 7-chloro-1-hydroxy-3H-2,1-benzoxaborole-6-carboxylate (30 mg, 0.1325 mmol, 15.66% of theoretical yield) as a white solid.

¹H NMR (400 MHz, DMSO-d₆) δ ppm 3.87 (s, 3H) 5.04 (s, 2H) 7.48 (d, J=7.83 Hz, 1H) 7.86 (d, J=7.82 Hz, 1H) 9.28 (br. s., 1H)

MS [M+H]⁺: 226.8 (rt 1.41 min)

### Example P13: Preparation of 7-chloro-1-hydroxy-3H-2,1-benzoxaborole-6-carboxylic acid

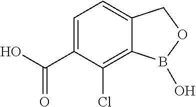 [SMILES: O=C(O)c1ccc2c(c1Cl)B(O)OC2]

To a stirred solution of methyl 7-chloro-1-hydroxy-3H-2,1-benzoxaborole-6-carboxylate, P12 (1.5 g, 6.6 mmol) in water (30 mL, 20 mL/g) was added sodium hydroxide (0.4, 10 mmol) dissolved in 10 ml water. Reaction mass was stirred at 50° C. for 12 h. The reaction mixture was cooled to 0-10° C. and diluted with 2N HCl to pH 2. Precipitation of fine white solid occurred, which was collected by filtration and washed with water and dried under vacuum to afford 7-chloro-1-hydroxy-3H-2,1-benzoxaborole-6-carboxylic acid (0.85 g, 60% of theoretical yield) as a white solid.

MS [M+H]⁺: 213.29 (rt 0.44 min)

### Example P14: Preparation of ethyl 7-chloro-1-hydroxy-3H-2,1-benzoxaborole-6-carboxylate

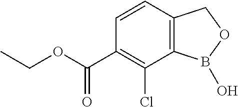 [SMILES: CCOC(=O)c1ccc2c(c1Cl)B(O)OC2]

To a solution of 7-chloro-1-hydroxy-3H-2,1-benzoxaborole-6-carboxylic acid, P13 (0.12 g, 0.56 mmol) in ethanol (10 ml) at 0° C. was added sulfuric acid (0.1 mL, 1 mL/g). The reaction mixture was then refluxed overnight. The reaction mixture was cooled to ambient temperature and solvents were evaporated off. The residual mass was diluted with water 20 ml and extracted with ethyl acetate (3×10 ml). The combined organic layer was then washed with sodium bicarbonate solution (10 ml), followed by water (2×10 ml), dried over sodium sulphate and concentrated to obtain the desired product ethyl 7-chloro-1-hydroxy-3H-2,1-benzoxaborole-6-carboxylate (0.083 g, 54% of theoretical yield) as a white solid

¹H NMR (DMSO-d₆, 400 MHz): δ (ppm) 9.29 (s, 1H), 7.83 (d, J=7.4 Hz, 1H), 7.46 (d, J=7.8 Hz, 1H), 5.03 (s, 2H), 4.32 (q, J=7.2 Hz, 2H), 1.32 (t, J=7.1 Hz, 3H)

MS [M+H]⁺: 241.18 (rt 1.22 min)

### Example P15: Preparation of 7-chloro-1-hydroxy-N,N-dimethyl-3H-2,1-benzoxaborole-6-carboxamide

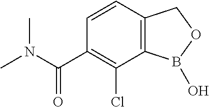 [SMILES: CN(C)C(=O)c1ccc2c(c1Cl)B(O)OC2]

To a stirred solution of 7-chloro-1-hydroxy-3H-2,1-benzoxaborole-6-carboxylic acid, P12 (0.1 g, 0.5 mmol) in dichloromethane (10 mL) were added N-methylmethanamine HCl (0.03 g 0.6 mmol), Propylphosphonic anhydride (0.6 g, 0.9 mmol, 50 mass % in EtOAc) and triethylamine (0.1 g, 1 mmol). The reaction mixture was stirred at ambient temperature for 3 h. Reaction mixture was diluted 10 ml water and aqueous layer was then extracted with dichloromethane (2×50 ml). The combined organic layer was washed with 2N HCl (1×10 ml), water (2×10 ml) finally with brine solution (2×10 ml). Organic layer was dried over sodium sulfate, filtered and evaporated completely to give crude compound. This crude mass thus obtained was purified by flash chromatography using 2.5% methanol in dichloromethane as eluent to afford desired compound 7-chloro-1-hydroxy-N,N-dimethyl-3H-2,1-benzoxaborole-6-carboxamide (0.018 g, 20% of theoretical yield) as a white solid.

¹H NMR (DMSO-d₆, 400 MHz): δ (ppm) 9.26 (s, 1H), 7.42 (s, 2H), 5.01 (s, 2H), 3.01 (s, 4H), 2.76 (s, 3H). MS [M+H]⁺: 239.8 (rt 0.38 min)

### Example P16: Preparation of N-[(2-fluorophenyl)methyl]-1-hydroxy-7-methoxy-3H-2,1-benzoxaborole-6-carboxamide

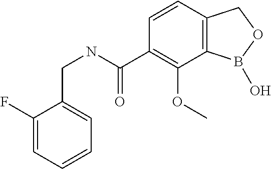 [SMILES: COc1c(C(=O)NCc2ccccc2F)ccc2c1B(O)OC2]

To a stirred solution of 1-hydroxy-7-methoxy-3H-2,1-benzoxaborole-6-carboxylic acid, P9 (0.25 g, 1.2 mmol) in dichloromethane (10 mL) were added (2-fluorophenyl) methanamine (0.18 g 1.44 mmol), Propylphosphonic anhydride (1.53 g, 2.4 mmol, 50 mass % in EtOAc) and triethylamine (0.365 g, 3.61 mmol). The reaction mixture was stirred at ambient temperature for 3 h. Reaction mixture was diluted 10 ml water and aqueous layer was then extracted with dichloromethane (2×50 ml). The combined organic layer was washed with 2N HCl (1×10 ml), water (2×10 ml) finally with brine solution (2×10 ml). The organic layer was dried over anhydrous sodium sulfate, filtered and evaporated completely to afford desired compound N-[(2-fluorophenyl)methyl]-1-hydroxy-7-methoxy-3H-2,1-benzoxaborole-6-carboxamide (0.08 g, 21% of theoretical yield) as a white solid

¹H NMR (DMSO-d₆, 400 MHz): δ (ppm) 9.35 (s, 1H), 8.74 (t, J=6.1 Hz, 1H), 7.79 (d, J=7.4 Hz, 1H), 7.41 (t, J=7.8 Hz, 1H), 7.26-7.35 (m, 1H), 7.09-7.24 (m, 3H), 5.01 (s, 2H), 4.53 (d, J=6.0 Hz, 2H), 4.08 (s, 3H).

MS [M+H]+: 316.32 (rt 1.18 min)

### Example P17: Preparation of 2,2,2-trifluoroethyl 1-hydroxy-7-methoxy-3H-2,1-benzoxaborole-6-carboxylate

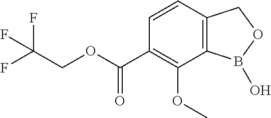 [SMILES: COc1c(C(=O)OCC(F)(F)F)ccc2c1B(O)OC2]

LC-MS: rt 1.86 min 290.8 (M+H).

To a stirred solution of 1-hydroxy-7-methoxy-3H-2,1-benzoxaborole-6-carboxylic acid (0.2 g, 1 mmol) in dichloromethane (2 mL, 10 mL/g) were added 2,2,2-trifluoroethanol (0.1 g, 1 mmol) 3-(ethyliminomethyleneamino)-N,N-dimethyl-propan-1-amine hydrochloride (0.2 g, 1.1 mmol) and 4-dimethylamino pyridine (0.02 g, 0.2 mmol). The reaction mixture was stirred at ambient temperature for 3 h. Reaction mixture was diluted 10 ml water and aqueous layer was then extracted with dichloromethane (2×50 ml). The combined organic layer was washed with 2N HCl (1×10 ml), water (2×10 ml) finally with brine solution (2×10 ml). The organic layer was dried over anhydrous sodium sulfate, filtered and evaporated completely to give crude compound. The crude obtained was purified by flash chromatography over silica gel with hexane/ethyl acetate 1:0 to 70:30 as eluent to afford desired compound 2,2,2-trifluoroethyl 1-hydroxy-7-methoxy-3H-2,1-benzoxaborole-6-carboxylate (0.124 g, 41% of theoretical yield) as a white solid.

¹H NMR (DMSO-d₆, 400 MHz): δ (ppm) 9.39 (s, 1H), 7.76 (d, J=7.8 Hz, 1H), 7.17 (d, J=7.9 Hz, 1H), 5.03 (s, 2H), 4.94 (q, J=9.1 Hz, 2H), 4.02 (s, 3H), 3.01 (s, 1H).

MS [M+H]+: 290.8 (rt 1.86 min)

TABLE T1-A
Table of further selected examples

| Cpd. | | RT | [M + H] | | MP |
|---|---|---|---|---|---|
| No. | compound | (min) | (measured) | Method | ° C. |
| 1 | methyl 1-hydroxy-7-methoxy-3H-2,1-benzoxaborole-6- | | | | 128-130 |
| | carboxylate | | | | |
| 2 | methyl 1,7-dihydroxy-3H-2,1-benzoxaborole-6-carboxylate | | | | 146-148 |
| 3 | methyl 7-chloro-1-hydroxy-3H-2,1-benzoxaborole-6- | | | | 127-129 |
| | carboxylate | | | | |
| 4 | methyl 7-ethoxy-1-hydroxy-3H-2,1-benzoxaborole-6- | | | | 76-75 |
| | carboxylate | | | | |
| 5 | N-[(2-fluorophenyl)methyl]-1-hydroxy-7-methoxy-3H-2,1- | | | | 158-159 |
| | benzoxaborole-6-carboxamide | | | | |
| 6 | N-[(4-chlorophenyl)methyl]-1-hydroxy-7-methoxy-3H-2,1- | | | | 179-180 |
| | benzoxaborole-6-carboxamide | | | | |
| 7 | 1-hydroxy-7-methoxy-N-(2-pyridylmethyl)-3H-2,1- | | | | 184-185 |
| | benzoxaborole-6-carboxamide | | | | |
| 8 | 1-hydroxy-7-methoxy-N-methyl-3H-2,1-benzoxaborole-6- | | | | 175-176 |
| | carboxamide | | | | |
| 9 | ethyl 7-chloro-1-hydroxy-3H-2,1-benzoxaborole-6-carboxylate | | | | 132-133 |
| 10 | 2,2,2-trifluoroethyl 1-hydroxy-7-methoxy-3H-2,1- | | | | 130-132 |
| | benzoxaborole-6-carboxylate | | | | |
| 11 | 1-hydroxy-7-methoxy-N,N-dimethyl-3H-2,1-benzoxaborole-6- | | | | 158-159 |
| | carboxamide | | | | |
| 12 | 2,2-difluoroethyl 1-hydroxy-7-methoxy-3H-2,1-benzoxaborole- | | | | 129-131 |
| | 6-carboxylate | | | | |
| 13 | 7-chloro-1-hydroxy-N,N-dimethyl-3H-2,1-benzoxaborole-6- | | | | 184-185 |
| | carboxamide | | | | |
| 14 | (4-cyanophenyl) 1-hydroxy-7-methoxy-3H-2,1-benzoxaborole- | | | | 191-192 |
| | 6-carboxylate | | | | |
| 15 | N-(4-cyanophenyl)-1-hydroxy-7-methoxy-3H-2,1- | | | | 219-220 |
| | benzoxaborole-6-carboxamide | | | | |
| 16 | methyl 7-(difluoromethoxy)-1-hydroxy-3H-2,1-benzoxaborole- | | | | 134-136 |
| | 6-carboxylate | | | | |
| 17 | N-ethyl-1-hydroxy-7-methoxy-N-phenyl-3H-2,1- | 1.31 | 311.89 | M2 | |
| | benzoxaborole-6-carboxamide | | | | |
| 18 | ethyl 4-[(1-hydroxy-7-methoxy-3H-2,1-benzoxaborole-6- | 1.18 | 363.08 | M2 | |
| | carbonyl)amino]piperidine-1-carboxylate | | | | |
| 19 | N-(2,5-dimethylphenyl)-1-hydroxy-7-methoxy-3H-2,1- | 1.54 | 312 | M2 | |
| | benzoxaborole-6-carboxamide | | | | |
| 20 | N-[1-(3,5-difluoro-2-pyridyl)ethyl]-1-hydroxy-7-methoxy-3H- | 1.33 | 348.99 | M2 | |
| | 2,1-benzoxaborole-6-carboxamide | | | | |
| 21 | N-(dimethylcarbamoyl)-1-hydroxy-7-methoxy-3H-2,1- | 0.92 | 278.97 | M2 | |
| | benzoxaborole-6-carboxamide | | | | |
| 22 | N-(4,6-dimethyl-2-pyridyl)-1-hydroxy-7-methoxy-3H-2,1- | 1.18 | 312.99 | M2 | |
| | benzoxaborole-6-carboxamide | | | | |
| 23 | N-[(2,4-dichlorophenyl)methyl]-1-hydroxy-7-methoxy-N- | 1.62 | 379.98 | M2 | |
| | methyl-3H-2,1-benzoxaborole-6-carboxamide | | | | |
| 24 | methyl 1-(1-hydroxy-7-methoxy-3H-2,1-benzoxaborole-6- | 1.08 | 334.02 | M2 | |
| | carbonyl)piperidine-4-carboxylate | | | | |
| 25 | 1-hydroxy-7-methoxy-N-(3-methylisothiazol-5-yl)-3H-2,1- | 1.19 | 305.56 | M2 | |
| | benzoxaborole-6-carboxamide | | | | |
| 26 | 1-hydroxy-7-methoxy-N-methyl-N-phenethyl-3H-2,1- | 1.35 | 326.02 | M2 | |
| | benzoxaborole-6-carboxamide | | | | |
| 27 | 1-hydroxy-7-methoxy-N-(2-methoxyethyl)-N-methyl-3H-2,1- | 0.99 | 279.94 | M2 | |
| | benzoxaborole-6-carboxamide | | | | |
| 28 | 1-hydroxy-7-methoxy-N-methyl-N-(4-methyl-5-sulfamoyl- | 1.14 | 397.73 | M2 | |
| | thiazol-2-yl)-3H-2,1-benzoxaborole-6-carboxamide | | | | |
| 29 | N-(4-ethylphenyl)-1-hydroxy-7-methoxy-3H-2,1- | 1.58 | 312.03 | M2 | |
| | benzoxaborole-6-carboxamide | | | | |
| 30 | 1-hydroxy-7-methoxy-N-methyl-N-(2-pyridyl)-3H-2,1- | 1.03 | 298.97 | M2 | |
| | benzoxaborole-6-carboxamide | | | | |
| 31 | N-[(2-chloro-6-methyl-phenyl)methyl]-1-hydroxy-7-methoxy- | 1.52 | 345.99 | M2 | |
| | 3H-2,1-benzoxaborole-6-carboxamide | | | | |
| 32 | 1-hydroxy-N,N-diisobutyl-7-methoxy-3H-2,1-benzoxaborole-6- | 1.59 | 320.12 | M2 | |
| | carboxamide | | | | |
| 33 | 1-hydroxy-7-methoxy-N-phenethyl-3H-2,1-benzoxaborole-6- | 1.35 | 312 | M2 | |
| | carboxamide | | | | |
| 34 | 1-hydroxy-N-isopropyl-7-methoxy-3H-2,1-benzoxaborole-6- | 1.09 | 249.99 | M2 | |
| | carboxamide | | | | |
| 35 | 1-hydroxy-N-isoxazol-4-yl-7-methoxy-3H-2,1-benzoxaborole- | 1.08 | 274.94 | M2 | |
| | 6-carboxamide | | | | |
| 36 | 1-hydroxy-N-isobutyl-7-methoxy-3H-2,1-benzoxaborole-6- | 1.22 | 264.01 | M2 | |
| | carboxamide | | | | |
| 37 | ethyl 1-[(1-hydroxy-7-methoxy-3H-2,1-benzoxaborole-6- | 1.12 | 320.06 | M2 | |
| | carbonyl)amino]cyclopropanecarboxylate | | | | |
| 38 | N-(2,4-diisopropyl-3-pyridyl)-1-hydroxy-7-methoxy-3H-2,1- | 1.03 | 369.1 | M2 | |
| | benzoxaborole-6-carboxamide | | | | |
| 39 | N-(2,5-dichloro-3-pyridyl)-1-hydroxy-7-methoxy-N-methyl-3H- | 1.3 | 366.97 | M2 | |
| | 2,1-benzoxaborole-6-carboxamide | | | | |
| 40 | N-(5-ethylsulfanyl-1-methyl-1,2,4-triazol-3-yl)-1-hydroxy-7- | 1.13 | 349.02 | M2 | |
| | methoxy-3H-2,1-benzoxaborole-6-carboxamide | | | | |
| 41 | N-(3-chloro-4-ethoxy-phenyl)-1-hydroxy-7-methoxy-3H-2,1- | 1.59 | 362.02 | M2 | |
| | benzoxaborole-6-carboxamide | | | | |
| 42 | 1-hydroxy-7-methoxy-N-(2-methyl-4-pyridyl)-3H-2,1- | 0.89 | 298.96 | M2 | |
| | benzoxaborole-6-carboxamide | | | | |
| 43 | 1-hydroxy-7-methoxy-N-(5-methyl-4H-1,2,4-triazol-3-yl)-3H- | 0.95 | 288.96 | M2 | |
| | 2,1-benzoxaborole-6-carboxamide | | | | |
| 44 | methyl 2-[(1-hydroxy-7-methoxy-3H-2,1-benzoxaborole-6- | 1.18 | 308 | M2 | |
| | carbonyl)amino]butanoate | | | | |
| 45 | 1-hydroxy-N-(2-isopropyl-5-methyl-pyrimidin-4-yl)-7-methoxy- | 1.18 | 342.06 | M2 | |
| | 3H-2,1-benzoxaborole-6-carboxamide | | | | |
| 46 | 1-hydroxy-7-methoxy-N-[5-(trifluoromethyl)-1H-1,2,4-triazol-3- | 1.23 | 343.56 | M2 | |
| | yl]-3H-2,1-benzoxaborole-6-carboxamide | | | | |
| 47 | 1-hydroxy-7-methoxy-N-[methyl(3- | 0.96 | 372.04 | M2 | |
| | pyridylmethyl)carbamothioyl]-3H-2,1-benzoxaborole-6- | | | | |
| | carboxamide | | | | |
| 48 | N-ethyl-1-hydroxy-7-methoxy-N-(3-pyridylmethyl)-3H-2,1- | 0.91 | 326.94 | M2 | |
| | benzoxaborole-6-carboxamide | | | | |
| 49 | 1-hydroxy-7-methoxy-N-methyl-N-[5-(trifluoromethyl)-1,3,4- | 1.56 | 373.99 | M2 | |
| | thiadiazol-2-yl]-3H-2,1-benzoxaborole-6-carboxamide | | | | |
| 50 | 1-hydroxy-7-methoxy-N-methyl-N-(1H-1,2,4-triazol-5-yl)-3H- | 1.02 | 288.95 | M2 | |
| | 2,1-benzoxaborole-6-carboxamide | | | | |
| 51 | 1-hydroxy-7-methoxy-N-(3-methoxy-1H-1,2,4-triazol-5-yl)-3H- | 1 | 304.96 | M2 | |
| | 2,1-benzoxaborole-6-carboxamide | | | | |
| 52 | methyl 3-[(1-hydroxy-7-methoxy-3H-2,1-benzoxaborole-6- | 1.39 | 342.03 | M2 | |
| | carbonyl)amino]benzoate | | | | |
| 53 | N-benzyl-1-hydroxy-N-isopropyl-7-methoxy-3H-2,1- | 1.5 | 340.06 | M2 | |
| | benzoxaborole-6-carboxamide | | | | |
| 54 | N-(4-chloro-2-fluoro-phenyl)-1-hydroxy-7-methoxy-3H-2,1- | 1.69 | 335.97 | M2 | |
| | benzoxaborole-6-carboxamide | | | | |
| 55 | 1-hydroxy-7-methoxy-N-[4-(trifluoromethoxy)phenyl]-3H-2,1- | 1.66 | 368.02 | M2 | |
| | benzoxaborole-6-carboxamide | | | | |
| 56 | 1-hydroxy-7-methoxy-N-(2-phenoxyethyl)-3H-2,1- | 1.34 | 328.03 | M2 | |
| | benzoxaborole-6-carboxamide | | | | |
| 57 | N-[1-(4-fluorophenyl)ethyl]-1-hydroxy-7-methoxy-3H-2,1- | 1.39 | 330.02 | M2 | |
| | benzoxaborole-6-carboxamide | | | | |
| 58 | N-(4,6-dimethoxypyrimidin-2-yl)-1-hydroxy-7-methoxy-3H-2,1- | 1.27 | 346.03 | M2 | |
| | benzoxaborole-6-carboxamide | | | | |
| 59 | N-[(6-chloro-3-pyridyl)methyl]-1-hydroxy-7-methoxy-3H-2,1- | 1.15 | 332.96 | M2 | |
| | benzoxaborole-6-carboxamide | | | | |
| 60 | N-tert-butyl-1-hydroxy-7-methoxy-3H-2,1-benzoxaborole-6- | 1.27 | 264.00 | M2 | |
| | carboxamide | | | | |
| 61 | methyl 3-[(1-hydroxy-7-methoxy-3H-2,1-benzoxaborole-6- | 1.07 | 344.03 | M2 | |
| | carbonyl)amino]pyrazine-2-carboxylate | | | | |
| 62 | 1-hydroxy-7-methoxy-N-[(2,2,3,3-tetrafluorocyclobutyl)methyl]- | 1.32 | 348.00 | M2 | |
| | 3H-2,1-benzoxaborole-6-carboxamide | | | | |
| 63 | 1-hydroxy-7-methoxy-N-propyl-3H-2,1-benzoxaborole-6- | 1.11 | 250.01 | M2 | |
| | carboxamide | | | | |
| 64 | 1-hydroxy-7-methoxy-N-[5-(trifluoromethyl)-1,3,4-thiadiazol-2- | 1.58 | 359.97 | M2 | |
| | yl]-3H-2,1-benzoxaborole-6-carboxamide | | | | |
| 65 | (1-hydroxy-7-methoxy-3H-2,1-benzoxaborol-6-yl)-(2,5,5- | 1.21 | 320.05 | M2 | |
| | trimethylmorpholin-4-yl)methanone | | | | |
| 66 | 1-hydroxy-7-methoxy-N-(5-methyl-2-pyridyl)-3H-2,1- | 1.24 | 298.90 | M2 | |
| | benzoxaborole-6-carboxamide | | | | |
| 67 | methyl 4-[(1-hydroxy-7-methoxy-3H-2,1-benzoxaborole-6- | 1.27 | 345.05 | M2 | |
| | carbonyl)amino]-1-methyl-pyrrole-2-carboxylate | | | | |
| 68 | N-[[3-chloro-5-(trifluoromethyl)-2-pyridyl]methyl]-1-hydroxy-7- | 1.54 | 401.01 | M2 | |
| | methoxy-3H-2,1-benzoxaborole-6-carboxamide | | | | |
| 69 | N-[(4-ethyl-1,3-dioxolan-2-yl)methyl]-1-hydroxy-7-methoxy-3H- | 1.19 | 322.04 | M2 | |
| | 2,1-benzoxaborole-6-carboxamide | | | | |
| 70 | 1-hydroxy-7-methoxy-N-[(5-methyl-2-furyl)methyl]-3H-2,1- | 1.26 | 302.00 | M2 | |
| | benzoxaborole-6-carboxamide | | | | |
| 71 | (3-amino-5-methyl-pyrazol-1-yl)-(1-hydroxy-7-methoxy-3H-2,1- | 1.06 | 287.96 | M2 | |
| | benzoxaborol-6-yl)methanone | | | | |
| 72 | (1-hydroxy-7-methoxy-3H-2,1-benzoxaborol-6-yl)-[2- | 0.98 | 291.98 | M2 | |
| | (hydroxymethyl)pyrrolidin-1-yl]methanone | | | | |
| 73 | 1,2,4-triazol-1-ylmethyl 1-hydroxy-7-methoxy-3H-2,1- | 0.78 | 290.23 | M1 | |
| | benzoxaborole-6-carboxylate | | | | |
| 74 | 2,2-difluoropropyl 1-hydroxy-7-methoxy-3H-2,1- | 1.22 | 287.22 | M1 | |
| | benzoxaborole-6-carboxylate | | | | |
| 75 | (2-methoxy-2-phenyl-ethyl) 1-hydroxy-7-methoxy-3H-2,1- | 1.44 | 343.30 | M1 | |
| | benzoxaborole-6-carboxylate | | | | |
| 76 | acetonyl 1-hydroxy-7-methoxy-3H-2,1-benzoxaborole-6- | 0.87 | 287.21 | M1 | |
| | carboxylate | | (Na adduct) | | |
| 77 | 3,4-dihydro-2H-pyran-2-ylmethyl 1-hydroxy-7-methoxy-3H-2,1- | 0.97 | 305.27 | M1 | |
| | benzoxaborole-6-carboxylate | | | | |
| 78 | (2,6-dimethoxypyrimidin-4-yl)methyl 1-hydroxy-7-methoxy-3H- | 1.28 | 361.28 | M1 | |
| | 2,1-benzoxaborole-6-carboxylate | | | | |
| 79 | (4-methoxy-4-oxo-but-2-ynyl) 1-hydroxy-7-methoxy-3H-2,1- | 1.16 | 305.23 | M1 | |
| | benzoxaborole-6-carboxylate | | | | |
| 80 | 3-(4-chlorophenyl)prop-2-ynyl 1-hydroxy-7-methoxy-3H-2,1- | 1.69 | 357.24 | M1 | |
| | benzoxaborole-6-carboxylate | | | | |
| 81 | 2-(4-chlorophenoxy)ethyl 1-hydroxy-7-methoxy-3H-2,1- | 1.55 | 363.24 | M1 | |
| | benzoxaborole-6-carboxylate | | | | |
| 82 | 2-(2-methylphenoxy)ethyl 1-hydroxy-7-methoxy-3H-2,1- | 1.54 | 343.26 | M1 | |
| | benzoxaborole-6-carboxylate | | | | |
| 83 | 1-(3-chlorophenyl)ethyl 1-hydroxy-7-methoxy-3H-2,1- | 1.64 | 369.21 | M1 | |
| | benzoxaborole-6-carboxylate | | (Na adduct) | | |
| 84 | 2-(4-methylthiazol-5-yl)ethyl 1-hydroxy-7-methoxy-3H-2,1- | 1.09 | 334.21 | M1 | |
| | benzoxaborole-6-carboxylate | | | | |
| 85 | benzyl 1-hydroxy-7-methoxy-3H-2,1-benzoxaborole-6- | 1.41 | 299.25 | M1 | |
| | carboxylate | | | | |
| 86 | pyrazol-1-ylmethyl 1-hydroxy-7-methoxy-3H-2,1- | 0.96 | 289.23 | M1 | |
| | benzoxaborole-6-carboxylate | | | | |
| 87 | (5-chloro-3-fluoro-2-pyridyl)methyl 1-hydroxy-7-methoxy-3H- | 1.35 | 352.22 | M1 | |
| | 2,1-benzoxaborole-6-carboxylate | | | | |
| 88 | [3-(trifluoromethyl)phenyl]methyl 1-hydroxy-7-methoxy-3H-2,1- | 1.61 | 367.25 | M1 | |
| | benzoxaborole-6-carboxylate | | | | |
| 89 | (3,3,3-trifluoro-1-phenyl-propyl) 1-hydroxy-7-methoxy-3H-2,1- | 1.61 | 403.26 | M1 | |
| | benzoxaborole-6-carboxylate | | (Na adduct) | | |
| 90 | [4-(methoxycarbonylamino)phenyl]methyl 1-hydroxy-7- | 1.23 | 394.28 | M1 | |
| | methoxy-3H-2,1-benzoxaborole-6-carboxylate | | (Na adduct) | | |
| 91 | 1-[3-(trifluoromethyl)-1H-pyrazol-5-yl]ethyl 1-hydroxy-7- | 1.34 | 371.25 | M1 | |
| | methoxy-3H-2,1-benzoxaborole-6-carboxylate | | | | |
| 92 | (2,6-dichloro-4-hydroxy-phenyl)methyl 1-hydroxy-7-methoxy- | 1.32 | 383.18 | M1 | |
| | 3H-2,1-benzoxaborole-6-carboxylate | | | | |
| 93 | 2-(isopropylideneamino)oxyethyl 1-hydroxy-7-methoxy-3H-2,1- | 1.17 | 308.27 | M1 | |
| | benzoxaborole-6-carboxylate | | | | |
| 94 | [2-(diethylamino)-2-oxo-ethyl] 1-hydroxy-7-methoxy-3H-2,1- | 1.03 | 322.31 | M1 | |
| | benzoxaborole-6-carboxylate | | | | |
| 95 | [2-(5-hydroxy-3-sulfanyl-1,2,4-triazin-6-yl)-2-methyl-propyl] 1- | 1.1 | 392.56 | M1 | |
| | hydroxy-7-methoxy-3H-2,1-benzoxaborole-6-carboxylate | | | | |
| 96 | (4-methylthiazol-2-yl)methyl 1-hydroxy-7-methoxy-3H-2,1- | 1.17 | 320.21 | M1 | |
| | benzoxaborole-6-carboxylate | | | | |
| 97 | (4,5-dichloroimidazol-1-yl)methyl 1-hydroxy-7-methoxy-3H- | 1.23 | 357.17 | M1 | |
| | 2,1-benzoxaborole-6-carboxylate | | | | |
| 98 | (5-methyl-2-propyl-1,3-dioxan-5-yl)methyl 1-hydroxy-7- | 1.54 | 365.33 | M1 | |
| | methoxy-3H-2,1-benzoxaborole-6-carboxylate | | | | |
| 99 | (2-ethyl-4-methyl-5H-oxazol-4-yl)methyl 1-hydroxy-7-methoxy- | 0.99 | 334.28 | M1 | |
| | 3H-2,1-benzoxaborole-6-carboxylate | | | | |
| 100 | 1,3-dithiolan-2-ylmethyl 1-hydroxy-7-methoxy-3H-2,1- | 1.3 | 349.19 | M1 | |
| | benzoxaborole-6-carboxylate | | (Na adduct) | | |
| 101 | [3-ethoxy-3-oxo-1-(trifluoromethyl)propyl] 1-hydroxy-7- | 1.47 | 399.25 | M1 | |
| | methoxy-3H-2,1-benzoxaborole-6-carboxylate | | (Na adduct) | | |
| 102 | 2-(5-acetoxy-3-methyl-pyrazol-1-yl)ethyl 1-hydroxy-7-methoxy- | 1.18 | 375.29 | M1 | |
| | 3H-2,1-benzoxaborole-6-carboxylate | | | | |
| 103 | (3,5-dimethylpyrazol-1-yl)methyl 1-hydroxy-7-methoxy-3H-2,1- | 1.14 | 317.28 | M1 | |
| | benzoxaborole-6-carboxylate | | | | |
| 104 | cyclopent-3-en-1-yl 1-hydroxy-7-methoxy-3H-2,1- | 1.32 | 275.25 | M1 | |
| | benzoxaborole-6-carboxylate | | | | |
| 105 | pent-3-ynyl 1-hydroxy-7-methoxy-3H-2,1-benzoxaborole-6- | 1.25 | 275.24 | M1 | |
| | carboxylate | | | | |
| 106 | 4-pyridylmethyl 1-hydroxy-7-methoxy-3H-2,1-benzoxaborole- | 0.68 | 300.24 | M1 | |
| | 6-carboxylate | | | | |
| 107 | 3-(3-methoxyphenyl)prop-2-ynyl 1-hydroxy-7-methoxy-3H-2,1- | 1.56 | 353.25 | M1 | |
| | benzoxaborole-6-carboxylate | | | | |
| 108 | dimethyl (2S)-2-(1-hydroxy-7-methoxy-3H-2,1-benzoxaborole- | 1.07 | 353.21 | M1 | |
| | 6-carbonyl)oxybutanedioate | | | | |
| 109 | 2-isopropoxyethyl 1-hydroxy-7-methoxy-3H-2,1- | 1.23 | 295.28 | M1 | |
| | benzoxaborole-6-carboxylate | | | | |
| 110 | phenethyl 1-hydroxy-7-methoxy-3H-2,1-benzoxaborole-6- | 1.48 | 313.2 | M1 | |
| | carboxylate | | | | |
| 111 | (2-ethoxy-2-oxo-ethyl) 1-hydroxy-7-methoxy-3H-2,1- | 1.12 | 295.22 | M1 | |
| | benzoxaborole-6-carboxylate | | | | |
| 112 | 2-[tert-butoxycarbonyl(methyl)amino]ethyl 1-hydroxy-7- | 1.38 | 389.38 | M1 | |
| | methoxy-3H-2,1-benzoxaborole-6-carboxylate | | | | |
| 113 | (2-oxo-1,3-dioxolan-4-yl)methyl 1-hydroxy-7-methoxy-3H-2,1- | 0.84 | 309.22 | M1 | |
| | benzoxaborole-6-carboxylate | | | | |
| 114 | 2-methyl-3-pyridyl)methyl 1-hydroxy-7-methoxy-3H-2,1- | 0.69 | 314.25 | M1 | |
| | benzoxaborole-6-carboxylate | | | | |
| 115 | (2,6-dichloro-4-pyridyl)methyl 1-hydroxy-7-methoxy-3H-2,1- | 1.49 | 368.16 | M1 | |
| | benzoxaborole-6-carboxylate | | | | |
| 116 | (3,5-dimethylphenyl)methyl 1-hydroxy-7-methoxy-3H-2,1- | 1.65 | 327.26 | M1 | |
| | benzoxaborole-6-carboxylate | | | | |
| 117 | (2,2-dimethyl-3-phenyl-propyl) 1-hydroxy-7-methoxy-3H-2,1- | 1.79 | 355.27 | M1 | |
| | benzoxaborole-6-carboxylate | | | | |
| 118 | (2-methylcyclopropyl)methyl 1-hydroxy-7-methoxy-3H-2,1- | 1.42 | 276.84 | M1 | |
| | benzoxaborole-6-carboxylate | | | | |
| 119 | (6-methyl-2-pyridyl)methyl 1-hydroxy-7-methoxy-3H-2,1- | 0.88 | 314.17 | M1 | |
| | benzoxaborole-6-carboxylate | | | | |
| 120 | (2,5-dichlorophenyl)methyl 1-hydroxy-7-methoxy-3H-2,1- | 1.7 | 367.15 | M1 | |
| | benzoxaborole-6-carboxylate | | | | |
| 121 | 1-ethylprop-2-ynyl 1-hydroxy-7-methoxy-3H-2,1- | 1.33 | 275.23 | M1 | |
| | benzoxaborole-6-carboxylate | | | | |
| 122 | 1,3-dioxan-5-yl 1-hydroxy-7-methoxy-3H-2,1-benzoxaborole-6- | 0.89 | 295.22 | M1 | |
| | carboxylate | | | | |
| 123 | 2-(2-pyridyl)ethyl 1-hydroxy-7-methoxy-3H-2,1-benzoxaborole- | 0.7 | 314.24 | M1 | |
| | 6-carboxylate | | | | |
| 124 | 2-(2-fluorophenyl)ethyl 1-hydroxy-7-methoxy-3H-2,1- | 1.49 | 331.24 | M1 | |
| | benzoxaborole-6-carboxylate | | | | |
| 125 | [(1S)-2-ethoxy-1-methyl-2-oxo-ethyl] 1-hydroxy-7-methoxy-3H- | 1.24 | 309.22 | M1 | |
| | 2,1-benzoxaborole-6-carboxylate | | | | |
| 126 | (4-hydroxy-3-methoxy-phenyl)methyl 1-hydroxy-7-methoxy- | 1.06 | 345.24 | M1 | |
| | 3H-2,1-benzoxaborole-6-carboxylate | | | | |
| 127 | (4-methoxyphenyl)methyl 1-hydroxy-7-methoxy-3H-2,1- | 1.39 | 329.16 | M1 | |
| | benzoxaborole-6-carboxylate | | | | |
| 128 | (2-methoxyphenyl)methyl 1-hydroxy-7-methoxy-3H-2,1- | 1.44 | 329.25 | M1 | |
| | benzoxaborole-6-carboxylate | | | | |
| 129 | isopentyl 1-hydroxy-7-methoxy-3H-2,1-benzoxaborole-6- | 1.53 | 279.25 | M1 | |
| | carboxylate | | | | |
| 130 | (1-methyl-3-phenyl-propyl) 1-hydroxy-7-methoxy-3H-2,1- | 1.65 | 341.28 | M1 | |
| | benzoxaborole-6-carboxylate | | | | |
| 131 | 1-hydroxy-7-methoxy-3H-2,1-benzoxaborole-6-carboxylic acid | | | | 181-182.4 |
| 132 | 3-phenylprop-2-ynyl 1-hydroxy-7-methoxy-3H-2,1- | | | | 122-124 |
| | benzoxaborole-6-carboxylate | | | | |

### Characterising Data:

Table 2 shows all the prepared examples with selected melting point and selected NMR data for prepared compounds. CDCl₃/D₂O and DMSO are used as solvents for NMR 400 MHz measurements. No attempt is made to list all characterising data in all cases.

In Table 2 and throughout the description that follows, temperatures are given in degrees Celsius; “NMR” means nuclear magnetic resonance spectrum; MS stands for mass spectrum; “%” is percent by weight, unless corresponding concentrations are indicated in other units. The following abbreviations are used throughout this description:

| | |
|---|---|
| m.p. = melting point | b.p. = boiling point. |
| s = Singlet | br = broad |
| d = Doublet | dd = doublet of doublets |
| t = Triplet | q = quartet |
| m = Multiplet | ppm = parts per million |

The following LC-MS methods were used to characterize the compounds:

### Method—M 1

ACQUITY SQD Mass Spectrometer from Waters (Single quadrupole mass spectrometer)
Ionisation method: Electrospray
Polarity: positive ions

### Capillary (kV) 3.00, Cone (V) 20.00, Extractor (V) 3.00, Source Temperature (° C.) 150, Desolvation

### Temperature (° C.) 400, Cone Gas Flow (L/Hr) 60, Desolvation Gas Flow (L/Hr) 700

Mass range: 100 to 800 Da
DAD Wavelength range (nm): 210 to 400
Method Waters ACQUITY UPLC with the following HPLC gradient conditions
(Solvent A: Water/Methanol 9:1, 0.1% formic acid and Solvent B: Acetonitrile, 0.1% formic acid)

| Time (minutes) | A (%) | B (%) | Flow rate (ml/min) |
|---|---|---|---|
| 0 | 100 | 0 | 0.75 |
| 2.5 | 0 | 100 | 0.75 |
| 2.8 | 0 | 100 | 0.75 |
| 3.0 | 100 | 0 | 0.75 |

Type of column: Waters ACQUITY UPLC HSS T3; Column length: 30 mm; Internal diameter of column: 2.1 mm; Particle Size: 1.8 micron; Temperature: 60° C.
The characteristic values obtained for each compound were the retention time (“Rₜ”, recorded in minutes) and the molecular ion as listed in Table 3.

### Method—M2

### Instrumentation

| | |
|---|---|
| Mass | 6410 Triple quadrupole Mass Spectrometer from |
| Spectrometer: | Agilent Technologies |
| HPLC: | Agilent 1200 Series HPLC |

### Optimized Mass Parameter

| | |
|---|---|
| Ionisation method: | Electrospray (ESI) |
| Polarity: | positive and Negative Polarity Switch |
| Scan Type: | MS2 Scan |
| Capillary (kV): | 4.00 |
| Fragmentor (V): | 100.00 |
| Gas Temperature (° C.): | 350 |
| Gas Flow (L/min): | 11 |
| Nebulizer Gas (psi): | 35 |
| Mass range: | 110 to 1000 Da |
| DAD Wavelength range (nm): | 190 to 400 |

### Optimized Chromatographic Parameter

### Gradient Conditions

(Solvent A: Water, 0.1% formic acid and Solvent B: Acetonitrile, 0.1% formic acid)

| Time (minutes) | A (%) | B (%) | Flow rate (ml/min) |
|---|---|---|---|
| 0 | 90 | 10 | 1.8 |
| 2.0 | 0 | 100 | 1.8 |
| 3.0 | 0 | 100 | 1.8 |
| 3.2 | 90 | 10 | 1.8 |
| 4.0 | 90 | 10 | 1.8 |

Type of column: Waters Xterra MS C18; Column length: 30 mm; Internal diameter of column: 4.6 mm; Particle Size: 3.5μ; Temperature: 30° C.

### BIOLOGICAL EXAMPLES: FUNGICIDAL ACTION

1. Alternaria solani/Tomato/Leaf Disc (Early Blight)

Tomato leaf disks cv. Baby are placed on agar in multiwell plates (24-well format) and sprayed with the formulated test compound diluted in water. The leaf disks are inoculated with a spore suspension of the fungus 2 days after application. The inoculated leaf disks are incubated at 23° C./21° C. (day/night) and 80% rh under a light regime of 12/12 h (light/dark) in a climate cabinet and the activity of a compound is assessed as percent disease control compared to untreated when an appropriate level of disease damage appears on untreated check disk leaf disks (5-7 days after application).
The following compounds gave at least 80% control of Alternaria solani at 200 ppm when compared to untreated control under the same conditions, which showed extensive disease development: 4, 64.

2. Botryotinia Fuckeliana (Botrytis cinerea)/Liquid Culture (Gray Mould)

Conidia of the fungus from cryogenic storage are directly mixed into nutrient broth (Vogels broth). After placing a (DMSO) solution of test compound into a microtiter plate (96-well format), the nutrient broth containing the fungal spores is added. The test plates are incubated at 24° C. and the inhibition of growth is determined photometrically 3-4 days after application.

The following compounds gave at least 80% control of Botryotinia fuckeliana at 20 ppm when compared to untreated control under the same conditions, which showed extensive disease development: 1, 2, 4, 64, 79, 86.

3. Glomerella lagenarium (Colletotrichum lagenarium)/Liquid Culture (Anthracnose)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is measured photometrically 3-4 days after application.

The following compounds gave at least 80% control of Glomerella lagenarium at 20 ppm when compared to untreated control under the same conditions, which showed extensive disease development: 1, 2, 3, 4, 9, 10, 12, 29, 64, 79, 82, 83, 84, 85, 86, 89, 94, 99, 100, 104, 105, 107, 110, 111, 117, 118, 121, 124, 127, 129, 130, 132

4. Blumeria Graminis f. Sp. Tritici (Erysiphe graminis f. Sp. Tritici)/Wheat/Leaf Disc Preventative (Powdery Mildew on Wheat)

Wheat leaf segments cv. Kanzler are placed on agar in a multiwell plate (24-well format) and sprayed with the formulated test compound diluted in water. The leaf disks are inoculated by shaking powdery mildew infected plants above the test plates 1 day after application. The inoculated leaf disks are incubated at 20° C. and 60% rh under a light regime of 24 h darkness followed by 12 h light/12 h darkness in a climate chamber and the activity of a compound is assessed as percent disease control compared to untreated when an appropriate level of disease damage appears on untreated check leaf segments (6-8 days after application).

The following compounds gave at least 80% control of Blumeria graminis f. sp. tritici at 200 ppm when compared to untreated control under the same conditions, which showed extensive disease development: 20.

5. Fusarium culmorum/Liquid Culture (Head Blight)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 3-4 days after application.

The following compounds gave at least 80% control of Fusarium culmorum at 20 ppm when compared to untreated control under the same conditions, which showed extensive disease development: 1, 2, 3, 4, 29, 79.

6. Gaeumannomyces Graminis/Liquid Culture (Take-all of Cereals)

Mycelial fragments of the fungus from cryogenic storage were directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 4-5 days after application.

The following compounds gave at least 80% control of Gaeumannomyces graminis at 20 ppm when compared to untreated control under the same conditions, which showed extensive disease development: 1, 2, 4, 6, 9, 10, 12, 14, 16, 64, 75, 77, 79, 80, 81, 82, 83, 84, 85, 86, 87, 88, 89, 90, 91, 92, 93, 94, 95, 96, 97, 98, 99, 100, 101, 102, 103, 104, 105, 107, 109, 110, 111, 114, 116, 117, 118, 120, 121, 124, 125, 127, 128, 129, 130, 132

7. Phaeosphaeria Nodorum (Septoria nodorum)/Wheat/Leaf Disc Preventative (Glume Blotch)

Wheat leaf segments cv. Kanzler are placed on agar in a multiwell plate (24-well format) and sprayed with the formulated test compound diluted in water. The leaf disks are inoculated with a spore suspension of the fungus 2 days after application. The inoculated test leaf disks are incubated at 20° C. and 75% rh under a light regime of 12 h light/12 h darkness in a climate cabinet and the activity of a compound is assessed as percent disease control compared to untreated when an appropriate level of disease damage appears in untreated check leaf disks (5-7 days after application).

The following compounds gave at least 80% control of Phaeosphaeria nodorum at 200 ppm when compared to untreated control under the same conditions, which showed extensive disease development: 1, 4, 132

8. Monographella nivalis (Microdochium nivale)/Liquid Culture (Foot Rot Cereals)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 4-5 days after application.

The following compounds gave at least 80% control of Monographella nivalis at 20 ppm when compared to untreated control under the same conditions, which showed extensive disease development: 1, 2, 3, 4, 6, 9, 10, 12, 29, 31, 33, 41, 45, 46, 49, 52, 54, 55, 57, 63, 64, 66, 75, 77, 79, 80, 81, 82, 83, 84, 85, 86, 88, 89, 90, 92, 94, 95, 96, 98, 99, 100, 104, 105, 107, 109, 110, 111, 116, 117, 118, 119, 121, 124, 125, 127, 128, 129, 130, 132

9. Mycosphaerella arachidis (Cercospora arachidicola)/Liquid Culture (Early Leaf Spot)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 4-5 days after application.

The following compounds gave at least 80% control of Mycosphaerella arachidis at 20 ppm when compared to untreated control under the same conditions, which showed extensive disease development: 1, 2, 3, 4, 8, 16, 79, 84, 86, 94, 99, 105, 110.

10. Phytophthora infestans/Tomato/Leaf Disc Preventative (Late Blight)

Tomato leaf disks are placed on water agar in multiwell plates (24-well format) and sprayed with the formulated test compound diluted in water. The leaf disks are inoculated with a spore suspension of the fungus 1 day after application. The inoculated leaf disks are incubated at 16° C. and 75% rh under a light regime of 24 h darkness followed by 12 h light/12 h darkness in a climate cabinet and the activity of a compound is assessed as percent disease control compared to untreated when an appropriate level of disease damage appears in untreated check leaf disks (5-7 days after application).

The following compounds gave at least 80% control of Phytophthora infestans at 200 ppm when compared to untreated control under the same conditions, which showed extensive disease development: 1, 2, 3, 9, 12, 86, 103, 109.

11. Plasmopara Viticola/Grape/Leaf Disc Preventative (Late Blight)

Grape vine leaf disks are placed on water agar in multiwell plates (24-well format) and sprayed with the formulated test compound diluted in water. The leaf disks are inoculated with a spore suspension of the fungus 1 day after application. The inoculated leaf disks are incubated at 19° C. and 80% rh under a light regime of 12 h light/12 h darkness in a climate cabinet and the activity of a compound is assessed as percent disease control compared to untreated when an appropriate level of disease damage appears in untreated check leaf disks (6-8 days after application).

The following compounds gave at least 80% control of Plasmopara viticola at 200 ppm when compared to untreated control under the same conditions, which showed extensive disease development: 3, 8, 86, 107, 111, 112.

12. Puccinia recondite f. Sp. Tritici/Wheat/Leaf Disc Curative (Brown Rust)

Wheat leaf segments cv. Kanzler are placed on agar in multiwell plates (24-well format). The leaf segments are inoculated with a spore suspension of the fungus. Plates are stored in darkness at 19° C. and 75% rh. The formulated test compound diluted in water is applied 1 day after inoculation. The leaf segments are incubated at 19° C. and 75% rh under a light regime of 12 h light/12 h darkness in a climate cabinet and the activity of a compound is assessed as percent disease control compared to untreated when an appropriate level of disease damage appears in untreated check leaf segments (6-8 days after application). The following compounds gave at least 80% control of Puccinia recondite f. sp. tritici at 200 ppm when compared to untreated control under the same conditions, which showed extensive disease development: 8, 18, 34.

13. Puccinia recondite f. Sp. Tritici/Wheat/Leaf Disc Preventative (Brown Rust)

Wheat leaf segments cv. Kanzler are placed on agar in multiwell plates (24-well format) and sprayed with the formulated test compound diluted in water. The leaf disks are inoculated with a spore suspension of the fungus 1 day after application. The inoculated leaf segments are incubated at 19° C. and 75% rh under a light regime of 12 h light/12 h darkness in a climate cabinet and the activity of a compound is assessed as percent disease control compared to untreated when an appropriate level of disease damage appears in untreated check leaf segments (7-9 days after application).

The following compounds gave at least 80% control of Puccinia recondite f. sp. tritici at 200 ppm when compared to untreated control under the same conditions, which showed extensive disease development: 3, 5,6,8,9,33,34,35,132

14. Pyrenophora teres/Barley/Leaf Disc Preventative (Net Blotch)

Barley leaf segments cv. Hasso are placed on agar in a multiwell plate (24-well format) and sprayed with the formulated test compound diluted in water. The leaf segments are inoculated with a spore suspension of the fungus 2 days after application. The inoculated leaf segments are incubated at 20° C. and 65% rh under a light regime of 12 h light/12 h darkness in a climate cabinet and the activity of a compound is assessed as disease control compared to untreated when an appropriate level of disease damage appears in untreated check leaf segments (5-7 days after application).

The following compounds gave at least 80% control of Pyrenophora teres at 200 ppm when compared to untreated control under the same conditions, which showed extensive disease development: 29.

15. Pythium ultimum/Liquid Culture (Seedling Damping Off)

Mycelia fragments and oospores of a newly grown liquid culture of the fungus are directly mixed into nutrient broth (PDB potato dextrose broth). After placing a (DMSO) solution of test compound into a microtiter plate (96-well format), the nutrient broth containing the fungal mycelia/spore mixture is added. The test plates are incubated at 24° C. and the inhibition of growth is determined photometrically 2-3 days after application.

The following compounds gave at least 80% control of Pythium ultimum at 20 ppm when compared to untreated control under the same conditions, which showed extensive disease development: 1, 2, 3, 4, 5, 6, 7, 8, 9, 10, 11, 12, 13, 14, 16, 18, 21, 22, 24, 27, 28, 29, 30, 31, 34, 35, 36, 37, 38, 39, 40, 42, 43, 44, 45, 46, 47, 48, 49, 50, 51, 52, 56, 57, 59, 60, 62, 63, 64, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 116, 118, 119, 121, 122, 123, 124, 125, 126, 127, 128, 129, 130, 132

16. Thanatephorus cucumeris (Rhizoctonia solani)/Liquid Culture (Foot Rot, Damping-Off)

Mycelia fragments of a newly grown liquid culture of the fungus are directly mixed into nutrient broth (PDB potato dextrose broth). After placing a (DMSO) solution of the test compounds into a microtiter plate (96-well format), the nutrient broth containing the fungal material is added. The test plates are incubated at 24° C. and the inhibition of growth is determined photometrically 3-4 days after application.

The following compounds gave at least 80% control of Thanatephorus cucumeris at 20 ppm when compared to untreated control under the same conditions, which showed extensive disease development: 1, 2, 3, 4, 9, 79, 83, 85, 86, 89, 94, 99, 100, 107, 111, 117, 124, 130.

17. Sclerotinia sclerotiorum/Liquid Culture (Cottony Rot)

Mycelia fragments of a newly grown liquid culture of the fungus are directly mixed into nutrient broth (PDB potato dextrose broth). After placing a (DMSO) solution of test compound into a microtiter plate (96-well format) the nutrient broth containing the fungal material is added. The test plates are incubated at 24° C. and the inhibition of growth is determined photometrically 3-4 days after application.

The following compounds gave at least 80% control of Sclerotinia sclerotiorum at 20 ppm when compared to untreated control under the same conditions, which showed extensive disease development: 1, 2, 3, 4, 16, 64, 79, 86, 94, 99

18. Mycosphaerella graminicola (Septoria tritici)/Liquid Culture (Septoria Blotch)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 4-5 days after application.

The following compounds gave at least 80% control of Mycosphaerella graminicola at 20 ppm when compared to untreated control under the same conditions, which showed extensive disease development: 1, 2, 3, 4, 9, 10, 12, 29, 79, 82, 83, 85, 86, 94, 99, 104, 105, 107, 110, 117, 118, 124, 129, 130, 132

1. A compounds of formula (I) 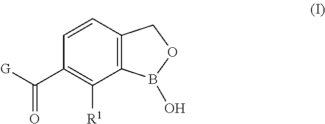
wherein
R¹ is fluorine, chlorine, bromine, cyano, nitro, hydroxy, C₁-C₄alkoxy, C₁-C₄haloalkoxy;
G=OR², NR³R⁴
R², R³ and R⁴ independently are H, C₁-C₆alkyl which can be substituted by one or more R⁵, C₁-C₆haloalkyl, six to 10 membered aryl which can be substituted by one or more R⁵, five to six membered heteroaryl which can be substituted by one or more R⁵ comprising 1 to 3 hetero atoms selected from the group consisting of nitrogen, oxygen and sulfur, it not being possible for the ring system to contain more than 2 oxygen atoms and more than 2 sulfur atoms, C₃-C₆cycloalkyl which can be substituted by one or more R⁵, heterocycloalkyl which can be substituted by one or more R⁵ containing 5 to 6 ring members comprising 1 to 3 hetero atoms selected from the group consisting of nitrogen, oxygen and sulfur, it not being possible for the ring system to contain more than 2 oxygen atoms and more than 2 sulfur atoms, C₁-C₆alkoxy which can be substituted by one or more R⁵, C₂-C₆alkenyl which can be substituted by one or more R⁵, C₂-C₆alkynyl which can be substituted by one or more R⁵, or
R³ and R⁴ form together with the nitrogen to which they are attached a 5 to 9 ring containing 1 to 3 hetero atoms selected from the group consisting of nitrogen, oxygen and sulfur, it not being possible for the ring system to contain more than 2 oxygen atoms and more than 2 sulfur atoms which can be substituted by one or more R⁵,
R⁵ is independently selected from oxo, —OH, CN, NO₂, F, Cl, —C(O)(C₁₋₄ alkoxy), —C(O)(C₁₋₄ alkyl), —C(O)—NH—(C₁₋₄ alkyl), —C(O)—N(C₁₋₄ alkyl)₂, C₃-C₇-cycloalkyl, 6 to 14 membered aryl, five to seven membered heteroaryl comprising 1 to 3 hetero atoms selected from the group consisting of nitrogen, oxygen and sulfur, it not being possible for the ring system to contain more than 2 oxygen atoms and more than 2 sulfur atoms, five to seven membered heterocycloalkyl comprising 1 to 3 hetero atoms selected from the group consisting of nitrogen, oxygen and sulfur, it not being possible for the ring system to contain more than 2 oxygen atoms and more than 2 sulfur atoms, C₁-C₄alkyl, C₁-C₄haloalkyl, C₂-C₄alkenyl, C₁-C₄haloalkenyl, C₂-C₆alkinyl, C₁-C₆alkoxy, C₂-C₆alkenyloxy, C₂-C₆haloalkenyloxy, C₂-C₆alkinyloxy, C₂-C₆haloalkinyl;
provided if R¹ is F then R² is not H.
and agronomically acceptable salts, stereoisomers, diastereoisomers, enantiomers, tautomers, atriopisomers and N-oxides of those compounds.

2. The compound of formula (I) according to claim 1 wherein
R¹ is OH, C₁-C₄alkoxy, C₁-C₄haloalkoxy;
G is OR², NR³R⁴;
R² is a C₁-C₆alkyl, C₁-C₆haloalkyl, phenyl-C₀-C₄-alkyl which can be substituted by one or more R⁵;
R³ is H, C₁-C₄-alkyl;
R⁴ is C₁-C₆alkyl which can be substituted by one or more R⁵, C₁-C₆haloalkyl, phenyl-C₀-C₄-alkyl which can be substituted by one or more R⁵, pyridyl-C₀-C₄-alkyl which can be substituted by one or more R⁵, C₃-C₆cycloalkyl which can be substituted by one or more R⁵, five to six ringmember comprising heterocycloalkyl-C₀-C₄-alkyl which can be substituted by one or more R⁵ wherein the heterocycloalkyl group comprises 1 to 3 heteroatoms selected from O, N and S, C₂-C₆alkenyl which can be substituted by one or more R⁵, C₂-C₆alkynyl which can be substituted by one or more R⁵, pyrimidinyl which can be substituted by one or more R⁵, triazolyl which can be substituted by one or more R⁵, pyrazinyl which can be substituted by one or more R⁵, pyrazolyl which can be substituted by one or more R⁵, can be pyrrolidinyl substituted by one or more R⁵;
R⁵ is independently selected from F, Cl, OH, CN, methyl, ethyl, methoxy, ethoxy, C₁-C₆alkyl-carboxylate, sulfonylamide, phenyl.

3. The compound of formula (I) according to claim 1 wherein
R¹ is OH, C₁-C₄alkoxy, C₁-C₄haloalkoxy;
G is OR², NR³R⁴;
R² is a C₁-C₆alkyl, C₁-C₄haloalkyl;
R³ is H, C₁-C₄-alkyl;
R⁴ is C₁-C₆alkyl which can be substituted by one or more R⁵, C₁-C₄haloalkyl, can be phenyl-C₀-C₄-alkyl substituted by one or more R⁵, pyridyl-C₀-C₄-alkyl which can be substituted by one or more R⁵, C₃-C₆cycloalkyl which can be substituted by one or more R⁵, five to six ringmember comprising heterocycloalkyl-C₀-C₄-alkyl which can be substituted by one or more R⁵ wherein the heterocycloalkyl group comprises 1 to 3 heteroatoms selected from O, N and S, C₂-C₆alkenyl which can be substituted by one or more R⁵, C₂-C₆alkynyl which can be substituted by one or more R⁵, pyrimidinyl which can be substituted by one or more R⁵, triazolyl which can be substituted by one or more R⁵, pyrazineyl which can be substituted by one or more R⁵, pyrazolyl which can be substituted by one or more R⁵, pyrrolidinyl which can be substituted by one or more R⁵;
R⁵ is independently selected from F, Cl, OH, CN, methyl, ethyl, methoxy, ethoxy, C₁-C₆alkyl-carboxylate, sulfonylamide, phenyl.

4. The compound of formula (I) according to claim 1, wherein G is OR².

5. The compound of formula (I) according to claim 1, wherein G is NR³R⁴.

6. A method for controlling or preventing infestation of a plant or plant propagation material and/or harvested crop susceptible to microbial attack, characterized in that an effective amount a compound of formula (I) as defined in claim 1 is applied to the plant or plant propagation material and/or harvested crop, or to parts thereof or the locus thereof.

7. A method of controlling phytopathogenic diseases on a plant or plant propagation material and/or harvested crop susceptible to microbial attack, characterized in that an effective amount a compound of formula (I) as defined in claim 1 is applied to the plant or plant propagation material and/or harvested crop, or to parts thereof or the locus thereof.

8. A composition comprising a fungicidally effective amount of a compound of formula (I) as defined in claim 1.
